(19) United States
(12) Patent Application Publication
(10) Pub. No.: US 2025/0108286 A1
(43) Pub. Date: Apr. 3, 2025

(54) PUZZLE TABLE

(71) Applicant: Meng Zhang, Shenzhen (CN)

(72) Inventors: Meng Zhang, Shenzhen (CN); Xiaoling Che, Dangyang (CN)

(21) Appl. No.: 18/977,571

(22) Filed: Dec. 11, 2024

Related U.S. Application Data
(63) Continuation-in-part of application No. 18/950,536, filed on Nov. 18, 2024.
Application No. 18/950,536 is a continuation-in-part of application No. 18/736,862, filed on Jun. 7, 2024, now Pat. No. 12,220,648.
Application No. 18/736,862 is a continuation of application No. 18/235,416, filed on Aug. 18, 2023, now Pat. No. 12,059,631.
Application No. 18/235,416 is a continuation-in-part of application No. 18/541,685, filed on Dec. 15, 2023, now Pat. No. 12,042,740.
Application No. 18/541,685 is a continuation-in-part of application No. 17/829,359, filed on Jun. 1, 2022, now Pat. No. 12,104,744.
Application No. 18/235,416 is a continuation-in-part of application No. 17/505,587, filed on Oct. 19, 2021, now Pat. No. 11,890,551.
Application No. 17/505,587 is a continuation-in-part of application No. 17/829,359, filed on Jun. 1, 2022, now Pat. No. 12,104,744.
Application No. 18/541,685 is a continuation-in-part of application No. 17/505,587, filed on Oct. 19, 2021, now Pat. No. 11,890,551.
Application No. 18/950,536 is a continuation-in-part of application No. 18/748,158, filed on Jun. 20, 2024.
Application No. 18/748,158 is a continuation-in-part of application No. 17/829,359, filed on Jun. 1, 2022, now Pat. No. 12,104,744.
Application No. 17/829,359 is a continuation-in-part of application No. 18/235,416, filed on Aug. 18, 2023, now Pat. No. 12,059,631.
Application No. 18/235,416 is a continuation-in-part of application No. 18/235,896, filed on Aug. 21, 2023, now Pat. No. 12,048,885.
Application No. 18/235,896 is a continuation of application No. 18/530,402, filed on Dec. 6, 2023, now Pat. No. 12,053,709.
Application No. 18/530,402 is a continuation-in-part of application No. 18/541,685, filed on Dec. 15, 2023, now Pat. No. 12,042,740.
Application No. 18/950,536 is a continuation-in-part of application No. 18/734,521, filed on Jun. 5, 2024.
Application No. 18/734,521 is a continuation-in-part of application No. 17/829,359, filed on Jun. 1, 2022, now Pat. No. 12,104,744.
Application No. 17/829,359 is a continuation-in-part of application No. 18/235,416, filed on Aug. 18, 2023, now Pat. No. 12,059,631.
Application No. 18/235,416 is a continuation-in-part of application No. 18/530,402, filed on Dec. 6, 2023, now Pat. No. 12,053,709.
Application No. 18/530,402 is a continuation of application No. 18/235,896, filed on Aug. 21, 2023, now Pat. No. 12,048,885.
Application No. 18/950,536 is a continuation-in-part of application No. 18/783,453, filed on Jul. 25, 2024.
Application No. 18/783,453 is a continuation-in-part of application No. 17/829,359, filed on Jun. 1, 2022, now Pat. No. 12,104,744.
Application No. 17/829,359 is a continuation-in-part of application No. 18/748,158, filed on Jun. 20, 2024.
Application No. 18/748,158 is a continuation-in-part of application No. 18/736,862, filed on Jun. 7, 2024, now Pat. No. 12,220,648.
Application No. 18/736,862 is a continuation-in-part of application No. 18/737,905, filed on Jun. 7, 2024.
Application No. 18/737,905 is a continuation-in-part of application No. 18/732,602, filed on Jun. 3, 2024, now Pat. No. 12,186,676.
Application No. 18/732,602 is a continuation of application No. 18/541,685, filed on Dec. 15, 2023, now Pat. No. 12,042,740.
Application No. 18/737,905 is a continuation of application No. 18/235,896, filed on Aug. 21, 2023, now Pat. No. 12,048,885.
Application No. 18/235,896 is a continuation of application No. 18/235,416, filed on Aug. 18, 2023, now Pat. No. 12,059,631.
Application No. 18/235,416 is a continuation-in-part of application No. 18/541,685, filed on Dec. 15, 2023, now Pat. No. 12,042,740.
Application No. 18/541,685 is a continuation-in-part of application No. 17/829,359, filed on Jun. 1, 2022, now Pat. No. 12,104,744.
Application No. 18/736,862 is a continuation of application No. 18/235,896, filed on Aug. 21, 2023, now Pat. No. 12,048,885.
(63) Continuation-in-part of application No. 18/956,131, filed on Nov. 22, 2024.
Application No. 18/956,131 is a continuation of application No. 18/732,602, filed on Jun. 3, 2024, now Pat. No. 12,186,676.
Application No. 18/732,602 is a continuation of application No. 18/541,685, filed on Dec. 15, 2023, now Pat. No. 12,042,740.
Application No. 18/541,685 is a continuation of application No. 17/505,587, filed on Oct. 19, 2021, now Pat. No. 11,890,551.

(30) Foreign Application Priority Data
Sep. 26, 2021 (CN) 2021111315541
Sep. 26, 2021 (CN) 2021223348151
Jun. 13, 2023 (CN) 202330364018X
Feb. 8, 2024 (CN) 202420292101X
Apr. 18, 2024 (CN) 2024302207152
Apr. 30, 2024 (CN) 2024302543261
May 23, 2024 (CN) 2024303095224
Jun. 19, 2024 (CN) 2024303774066

(51) Int. Cl. A63F 9/10; F16C 19/06; F16M 11/08; F16M 11/10

(52) U.S. Cl. CPC A63F 9/1044; F16C 19/06; F16M 11/08; F16M 11/10

(57) ABSTRACT

The present disclosure provides a puzzle table. The puzzle table includes at least two board units and at least one connecting assembly configured to connect two adjacent board units. Each connecting assembly comprises an inserting assembly and a receiving assembly. The inserting assembly is mounted on one of the two adjacent board units, while the receiving assembly is mounted on the other board unit. When the inserting assembly and the receiving assembly are inserted into each other, the two adjacent board units are spliced with each other, and upper faces of the two adjacent board units are substantially flush with each other. The inserting assembly and the receiving assembly are capable of being inserted into each other, such that the at least two puzzle plates can be spliced with each other in parallel to form an assembled body.

### CROSS-REFERENCE TO RELATED APPLICATIONS

This application is a continuation in part of U.S. patent application Ser. No. 18/956,131, and a continuation of U.S. patent application Ser. No. 18/950,536, the contents of each of which are incorporated by reference in their entirety.

U.S. patent application Ser. No. 18/956,131 is a continuation of U.S. Pat. No. 1,873,602. U.S. Pat. No. 1,873,602 is a continuation of U.S. patent application Ser. No. 18/541,685, which is a continuation of U.S. patent application Ser. No. 17/505,587.

U.S. patent application Ser. No. 18/950,536 is a continuation in part of U.S. patent application Ser. No. 18/736,862, a continuation in part of U.S. patent application Ser. No. 18/748,158, a continuation in part of U.S. patent application Ser. No. 18/734,521, and a continuation of U.S. patent application Ser. No. 18/783,453. Through U.S. patent application Ser. No. 18/950,536, this application claims priority to Chinese Patent Application No. 2024303774066 and Chinese Patent Application No. 2024303095224.

The U.S. patent application Ser. No. 18/736,862 is a continuation of U.S. patent application Ser. No. 18/235,896, a continuation of U.S. patent application Ser. No. 18/235,416, a continuation in part of U.S. patent application Ser. No. 18/541,685, and a continuation in part of U.S. patent application Ser. No. 17/829,359. The U.S. patent application Ser. No. 18/235,416 is a continuation in part U.S. patent application Ser. No. 17/505,587 and a continuation in part of U.S. patent application Ser. No. 17/829,359. The U.S. patent application Ser. No. 18/235,896 is a continuation in part of U.S. patent application Ser. No. 17/505,587 and a continuation in part of U.S. patent application Ser. No. 17/829,359. The U.S. patent application Ser. No. 18/541,685 is a continuation of U.S. patent application Ser. No. 17/505,587. Through U.S. patent application Ser. No. 17/505,587, this application claims priority to Chinese Patent Application No. 2021111315541, filed on Sep. 26, 2021, and Chinese Patent Application No. 2021223348151, also filed on Sep. 26, 2022. Through U.S. patent application Ser. No. 18/235,896, this application claims priority to Chinese Patent Application No.202330364018X, filed Jun. 13, 2023.

The U.S. patent application Ser. No. 18/748,158 is a continuation in part of U.S. patent application Ser. No. 17/829,359, a continuation in part of U.S. patent application Ser. No. 18/235,416, a continuation in part of U.S. patent application Ser. No. 18/235,896, a continuation of U.S. patent application Ser. No. 18/530,402, and a continuation in part of U.S. patent application Ser. No. 18/541,685. The U.S. patent application Ser. No. 18/530,402 is a continuation in part of U.S. patent application Ser. No. 17/505,587, a continuation in part of U.S. patent application Ser. No. 17/829,359, and a continuation in part of U.S. patent application Ser. No. 18/235,416.

The U.S. patent application Ser. No. 18/734,521 is a continuation in part of U.S. patent application Ser. No. 17/829,359, a continuation in part of U.S. patent application Ser. No. 18/235,416, a continuation of U.S. patent application Ser. No. 18/235,896, and a continuation in part of U.S. patent application Ser. No. 18/530,402. Through U.S. patent application Ser. No. 18/734,521, this application claims priority to Chinese Patent Application 2024302207152, Chinese Patent Application No. 202420292101X, and Chinese Patent Application 2024302543261.

The U.S. patent application Ser. No. 18/783,453 is a continuation in part of U.S. patent application Ser. No. 17/829,359, a continuation in part of U.S. patent application Ser. No. 18/748,158, a continuation in part of U.S. patent application Ser. No. 18/736,862, a continuation in part of U.S. patent application Ser. No. 18/737,905, and a continuation in part of U.S. patent application Ser. No. 18/732,602.

### FIELD

The present disclosure relates to the field of puzzle tools, and in particular to a puzzle table.

### BACKGROUND

Existing puzzle tables are generally plate-shaped and have a relatively large area, resulting in high costs for packaging and transporting and inconvenience in storage.

### SUMMARY

The present disclosure provides a puzzle table. The puzzle table includes at least two board units, wherein each board unit comprises a puzzle plate for playing a plurality of puzzle pieces thereon. at least one connecting assembly, wherein each of the at least one connecting assembly is configured to connect two adjacent board units of the at least two board units. wherein each of the at least one connecting assembly comprises an inserting assembly and a receiving assembly, the inserting assembly is mounted on one of the at least two board units, the receiving assembly is mounted on an adjacent other of the at least two board units, and the inserting assembly and the receiving assembly are capable of being inserted into each other. when the inserting assembly and the receiving assembly are inserted into each other, the at least two board units are spliced with each other, and upper faces of the at least two the puzzle plates are substantially flush with each other.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is an illustrative isometric view of a puzzle table according to a first embodiment of the present invention, placed on a playing surface.

FIG. 2 is an exploded perspective view of the puzzle table shown in FIG. 1.

FIG. 3 is an illustrative isometric view of the puzzle table shown in FIG. 1, presented from another angle.

FIG. 4 is an exploded perspective view of the puzzle table shown in FIG. 3.

FIG. 5 is a top view of a puzzle board shown in FIG. 1.

FIG. 6 is an upward view of the puzzle board shown in FIG. 1.

FIG. 7 is an exploded perspective view of board units shown in FIG. 1.

FIG. 8 is an exploded perspective view of the board units shown in FIG. 4.

FIG. 9 is an illustrative isometric view of the board units in a first step of the assembly sequence shown in FIG. 1.

FIG. 10 is an illustrative isometric view of the board units in a second step of the assembly sequence shown in FIG. 1.

FIG. 11 is an illustrative isometric view of the board units in a third step of the assembly sequence shown in FIG. 1.

FIG. 12 is an illustrative isometric view of the puzzle board shown in FIG. 1.

FIG. 13 is a cross-sectional view along line a-a of the puzzle board shown in FIG. 12.

FIG. 14 is a cross-sectional view along line b-b of the puzzle board shown in FIG. 12.

FIG. 15 is a cross-sectional view along line c-c of the puzzle board shown in FIG. 12.

FIG. 16 is a cross-sectional view along line d-d of the puzzle board shown in FIG. 12.

FIG. 17 is a cross-sectional view along line e-e of the puzzle board shown in FIG. 12.

FIG. 18 is a half-sectional view of the puzzle board shown in FIG. 12.

FIG. 19 is an illustrative isometric view of a first corner part from one angle.

FIG. 20 is an illustrative isometric view of the first corner part, presented from another angle.

FIG. 21 is a half-sectional view of the first corner part.

FIG. 22 is an illustrative isometric view of the first connecting part from one angle.

FIG. 23 is an illustrative isometric view of the first connecting part, presented from another angle.

FIG. 24 is an illustrative isometric view of a second corner part from one angle.

FIG. 25 is an illustrative isometric view of the second corner part, presented from another angle.

FIG. 26 is a half-sectional view of the second corner part.

FIG. 27 is an illustrative isometric view of a connection between the first corner part and the first connecting part.

FIG. 28 is a half-sectional view of the connection structure between the first corner part and the first connecting part.

FIG. 29 is an illustrative isometric view of a connection between the first corner part and the fourth corner part.

FIG. 30 is a half-sectional view of the connection structure between the first corner part and the fourth corner part.

FIG. 31 is an illustrative isometric view of a connection between the first connecting part and the second connecting part.

FIG. 32 is a half-sectional view of the connection structure between the first connecting part and the second connecting part.

FIG. 33 is an exploded perspective view of a rotating device shown in FIG. 1.

FIG. 34 is the connection structure between the rotating device and the puzzle board shown in FIG. 1.

FIG. 35 is an illustrative isometric view of a puzzle table according to a first embodiment of the present invention, placed on a playing surface.

FIG. 36 is an exploded perspective view of the puzzle table shown in FIG. 35.

FIG. 37 is an illustrative isometric view of the puzzle table shown in FIG. 35, presented from another angle.

FIG. 38 is an exploded perspective view of the puzzle table shown in FIG. 37.

FIG. 39 is an exploded perspective view of the board units shown in FIG. 35.

FIG. 40 is an exploded perspective view of the board units shown in FIG. 38.

FIG. 41 is an upward view of the puzzle board shown in FIG. 35.

FIG. 42 is a cross-sectional view along line g-g of the puzzle board shown in FIG. 35.

FIG. 43 is an illustrative isometric view of a first corner part shown in FIG. 35.

FIG. 44 is an illustrative isometric view of a second corner part shown in FIG. 35.

FIG. 45 is an illustrative isometric view of the first corner part, presented from another angle.

FIG. 46 is an illustrative isometric view of the first corner part, presented from a third angle.

FIG. 47 is a half-sectional view of the first corner part.

FIG. 48 is an illustrative isometric view of a first connecting part from one angle.

FIG. 49 is an illustrative isometric view of the first connecting part, presented from another angle.

FIG. 50 is an illustrative isometric view of the second corner part, presented from another angle.

FIG. 51 is an illustrative isometric view of the second corner part, presented from a third angle.

FIG. 52 is a half-sectional view of the second corner part.

FIG. 53 is an illustrative isometric view of a connection between the first corner part and the first connecting part.

FIG. 54 is a half-sectional view of the connection structure between the first corner part and the first connecting part.

FIG. 55 is an illustrative isometric view of a connection between the first connecting part and the second connecting part.

FIG. 56 is a half-sectional view of the connection structure between the first connecting part and the second connecting part.

FIG. 57 is an illustrative isometric view of a connection between the first corner part and the fourth corner part.

FIG. 58 is a half-sectional view of the connection structure between the first corner part and the fourth corner part.

FIG. 59 is an illustrative isometric view of a rotating device shown in FIG. 35.

FIG. 60 is an illustrative isometric view of the rotating device shown in FIG. 35, presented from a different angle.

FIG. 61 is an exploded perspective view of the rotating device shown in FIG. 59.

FIG. 62 is an exploded perspective view of the rotating device shown in FIG. 60.

### DETAILED DESCRIPTION

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

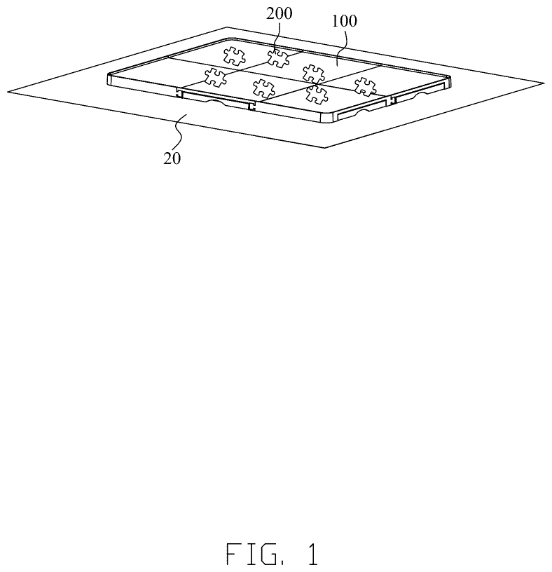

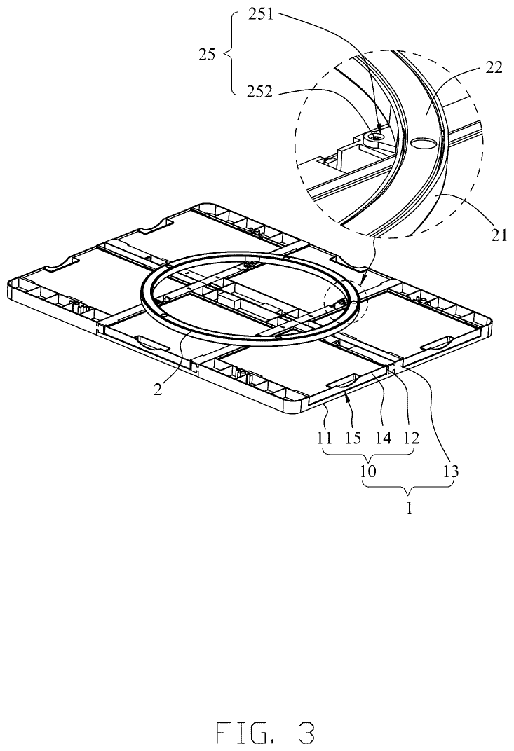

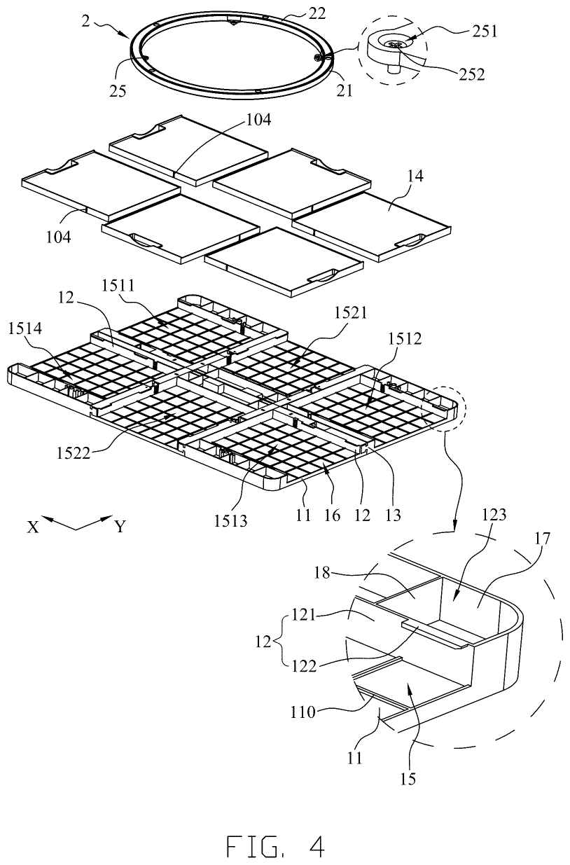

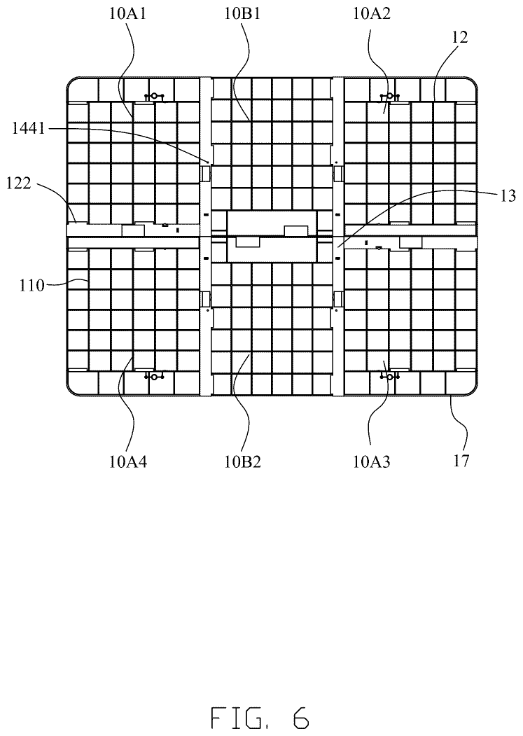

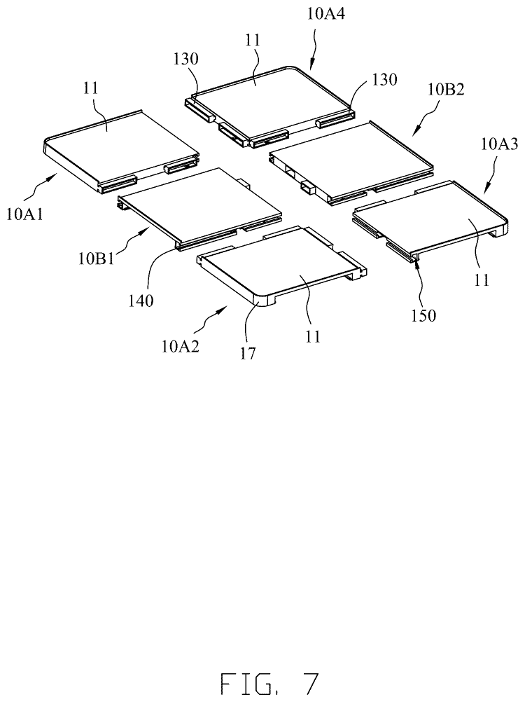

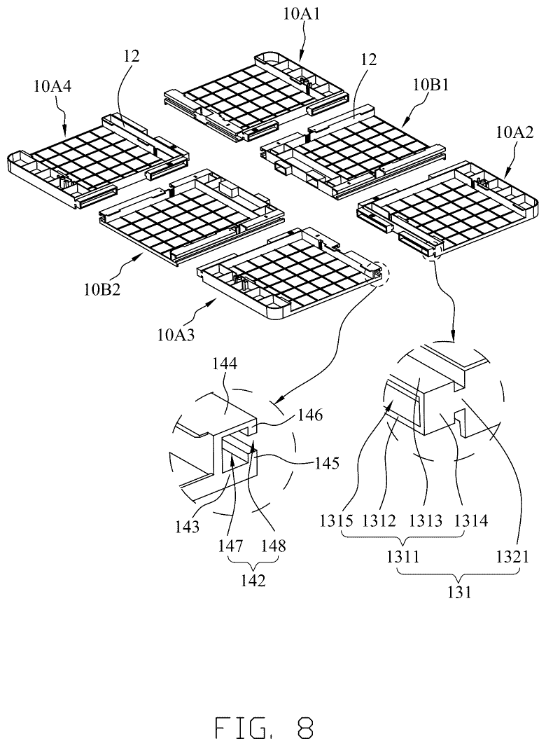

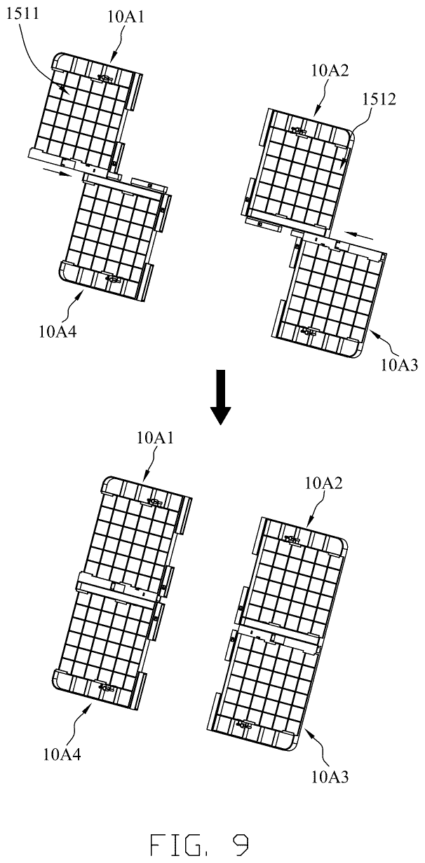

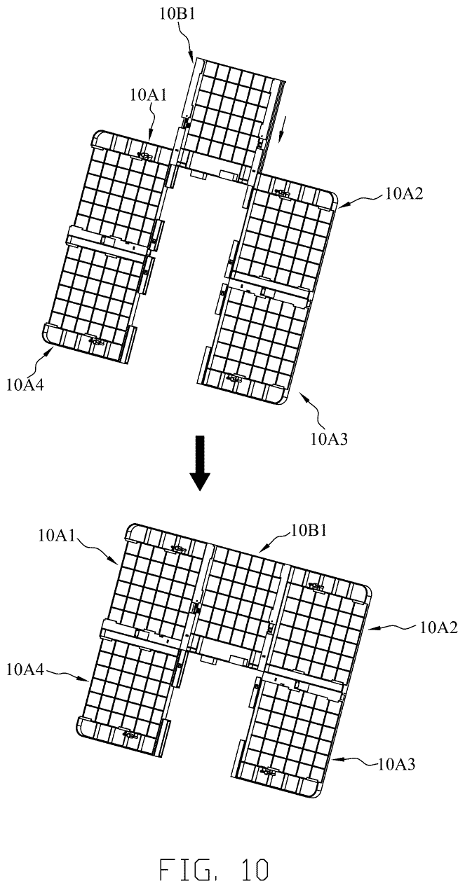

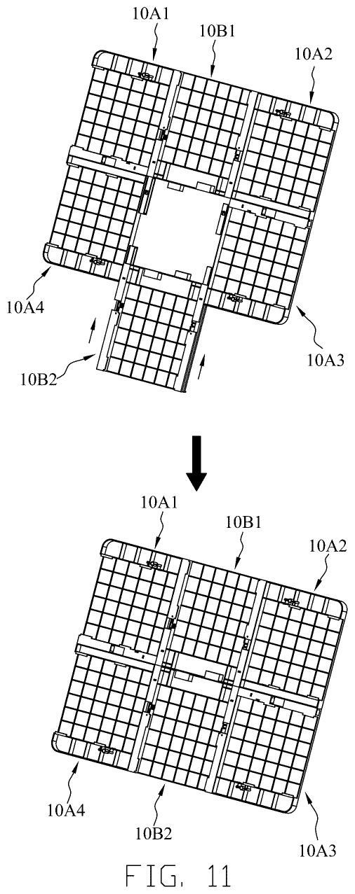

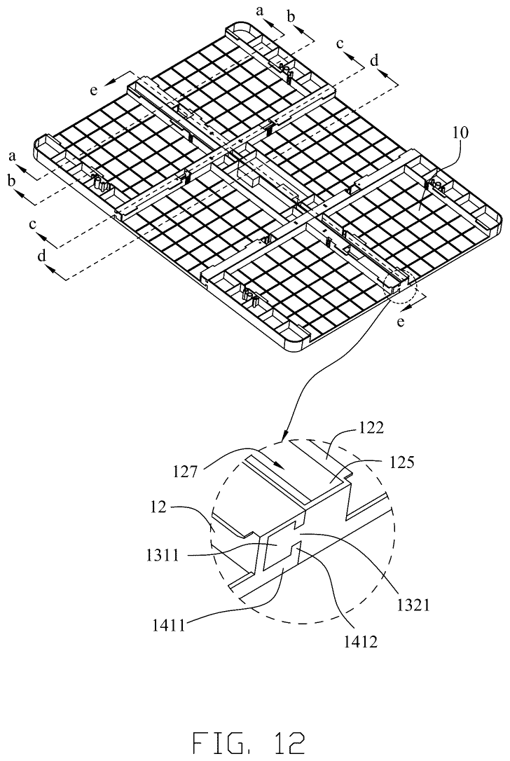

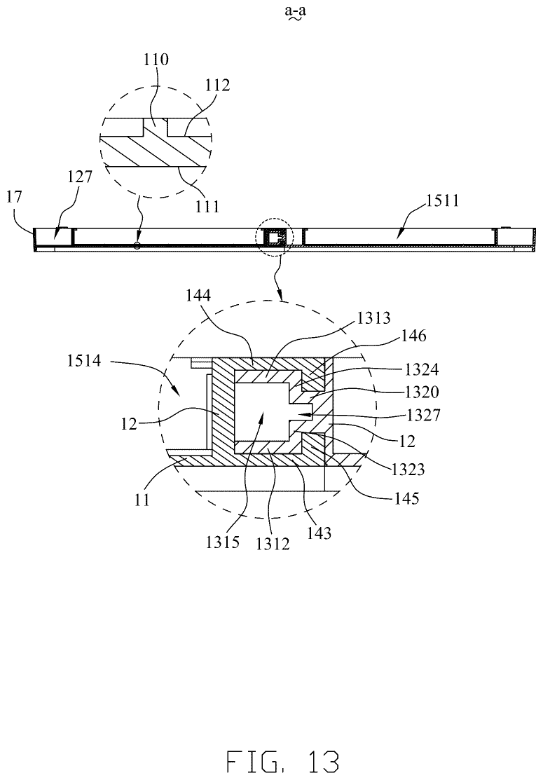

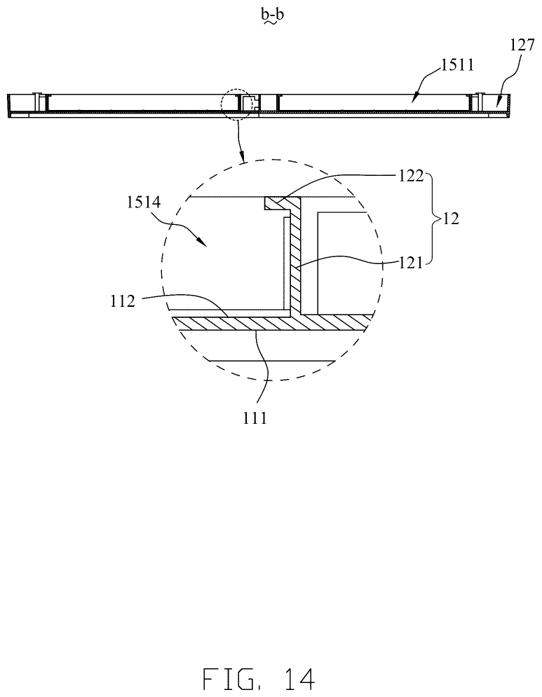

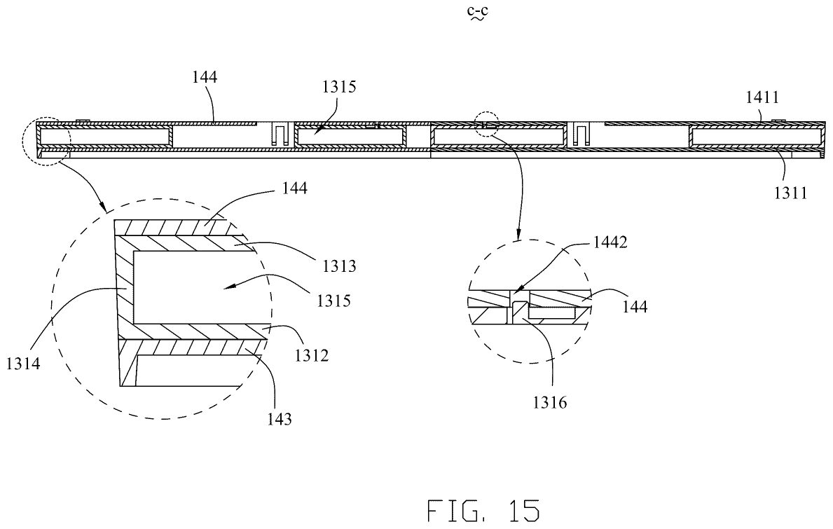

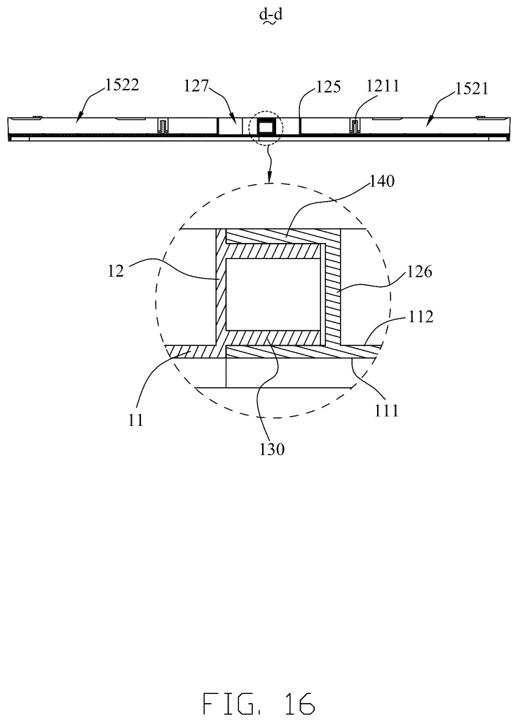

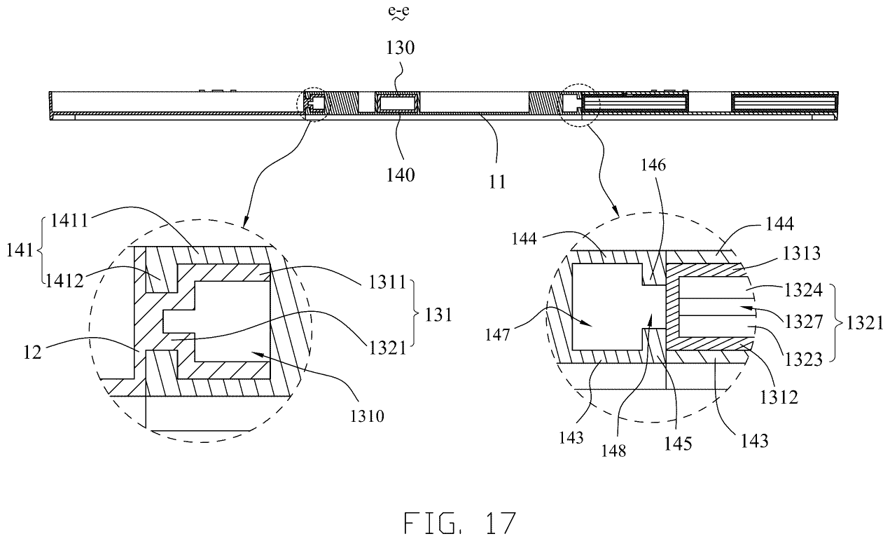

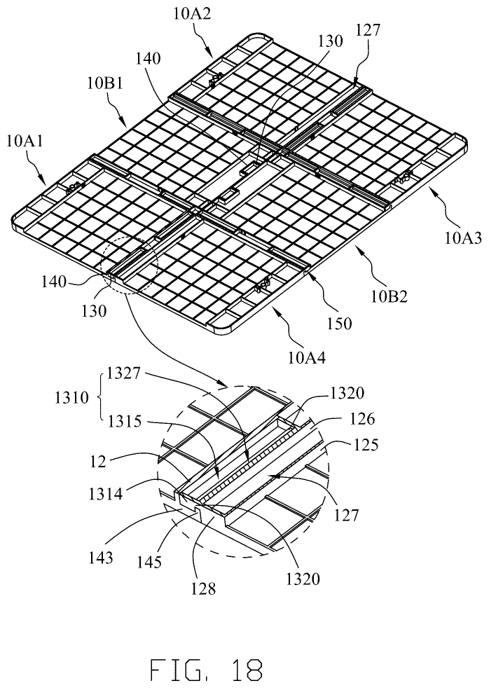

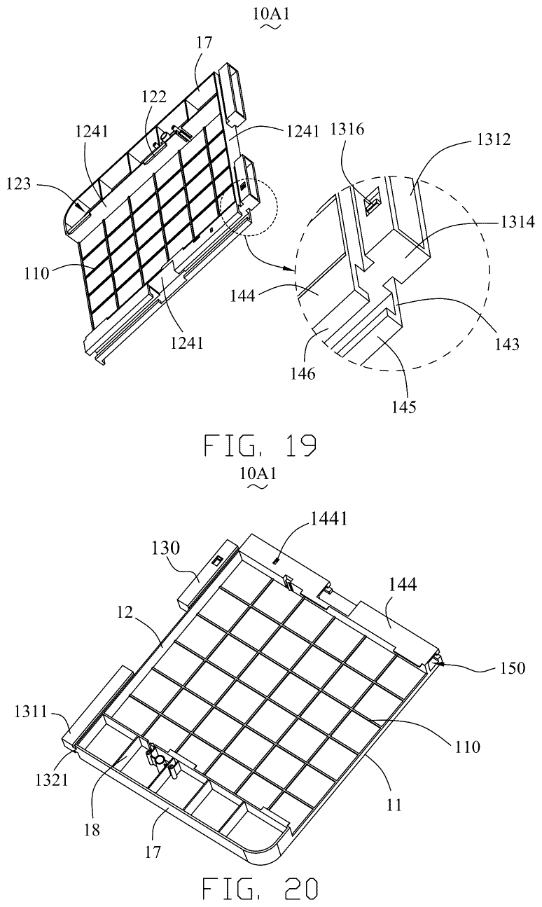

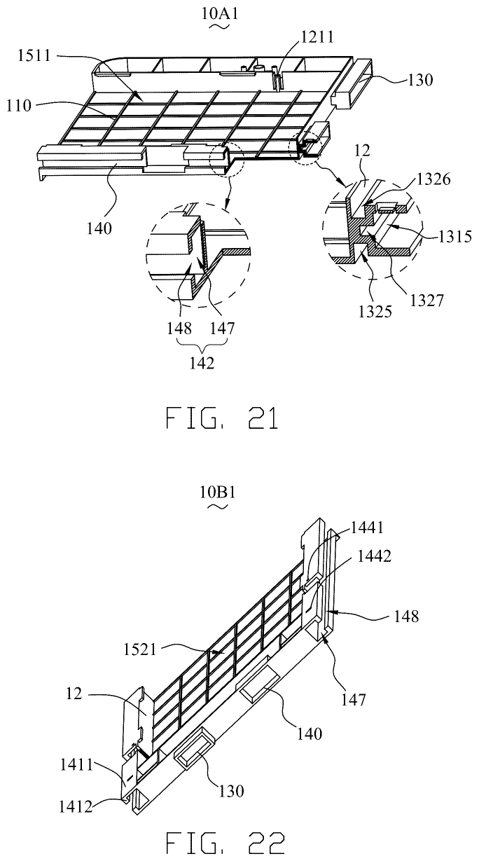

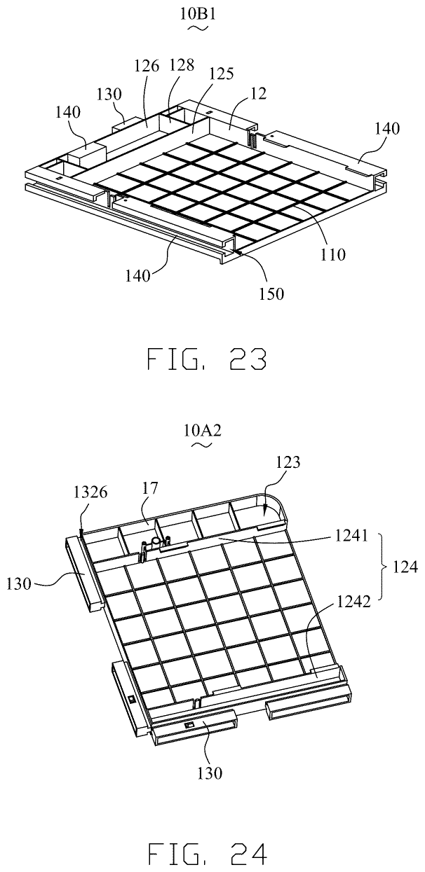

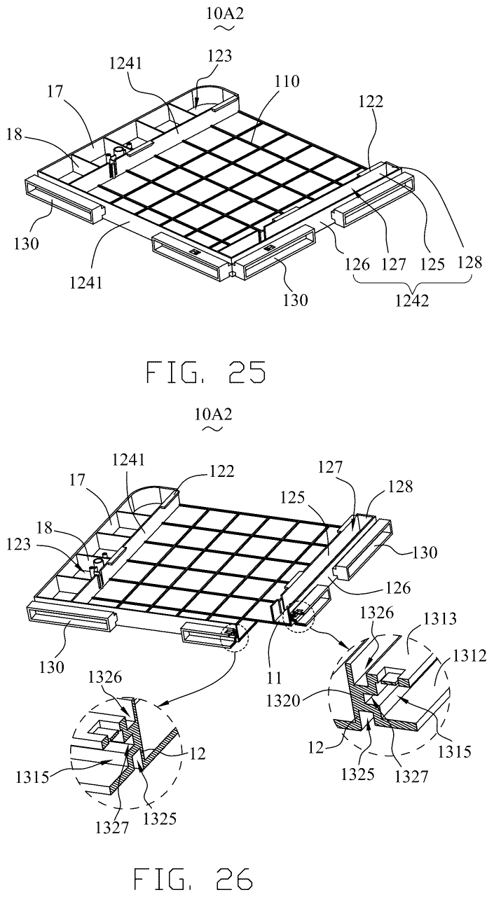

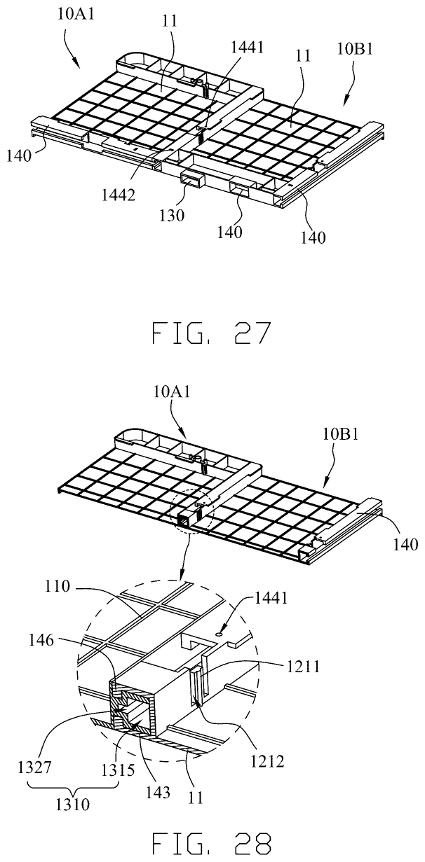

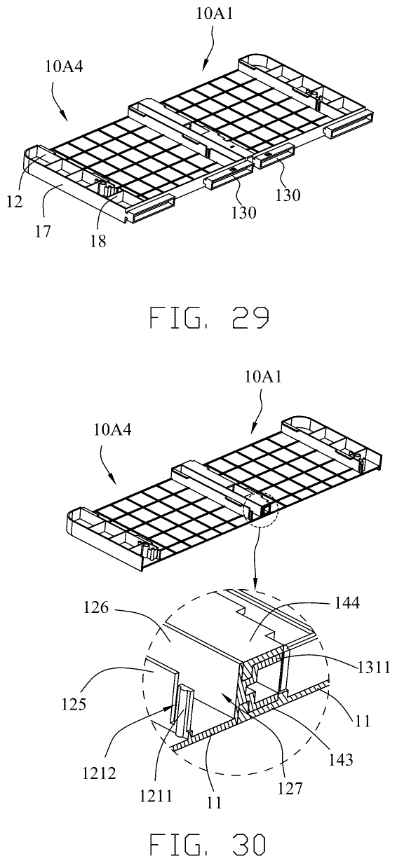

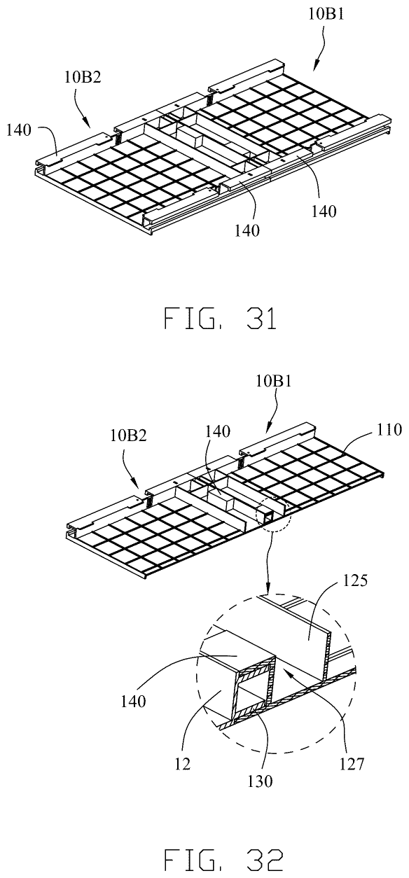

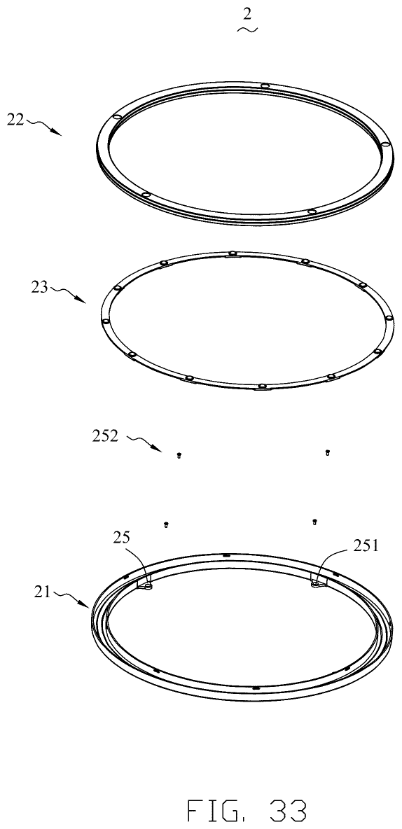

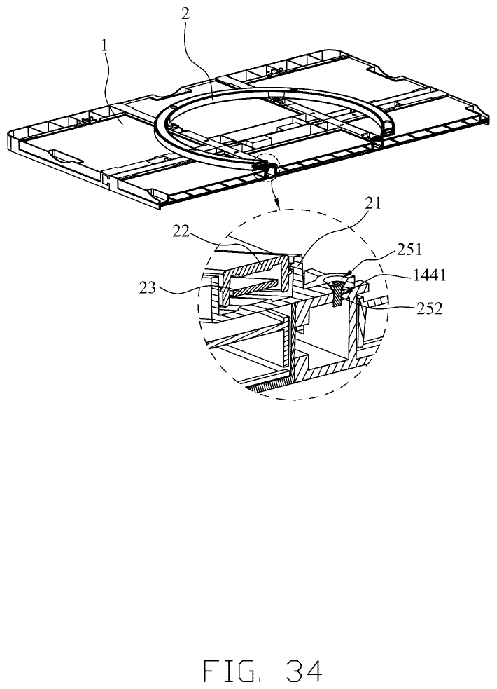

As shown in FIGS. 1 to 34, schematic views of a puzzle table 100 from a first embodiment of the present disclosure are presented. The puzzle table 100 is designed for a user or player to assemble and play with a plurality of puzzle pieces 200 thereon. Accordingly, the puzzle table 100 comprises a puzzle board 1 and at least one rotating device 2 located below the puzzle board 1 and connected to the puzzle board 1. The puzzle table 100 may be placed on any playing surface 20, such as a table, wall, floor, or similar structure. The rotating device 2 supports the puzzle board I relative to the playing surface 20 for driving the puzzle board 1 to rotate and move in any direction, thereby changing positions of the puzzle board 1 relative to the user.

The puzzle board 1 comprises at least two board units 10 and at least one connecting assembly 13 configured to detachably connect two adjacent board units among the at least two board units. By enabling the connection between the adjacent board units 10 to be detachable, the puzzle board 1 may be stored and transported without requiring prior assembly. This feature allows it to be stored and transferred in the form of individual board units 10, which reduces the packaging volume of the puzzle table 100. When needed, the user can assemble the board units 10; after use, they may easily disassemble the puzzle board 1 back into multiple board units 10 for convenient storage and transfer.

Each board unit 10 comprises a puzzle plate 11, a reinforcing wall 12 supporting the puzzle plate 11, at least one drawer cavity 15 formed by the puzzle plate 11 and the reinforcing wall 12, and at least one puzzle drawer 14 installed within the drawer cavity 15. The reinforcing wall 12 forms a semi-enclosed structure with a drawer opening 16, allowing the puzzle drawer 14 to be pulled and slid out of the drawer cavity 15 through the drawer opening 16. To ensure that the puzzle drawer 14 may be smoothly drawn out from the drawer cavity 15, the drawer opening 16 needs to be oriented outward.

The puzzle board 1, with an even thickness, may take any shape, such as circular, square, rectangular, and so on. Since adjacent board units 10 need to be interconnected to reduce the joint area, the board units 10 are typically chosen to have square structures, such as rectangular or square shapes. Consequently, the assembled puzzle board I will also be rectangular or square, providing a uniform structure. As shown in FIGS. 1-8 and 11, the puzzle board 1 is embodied in a rectangular shape, defining two longer longitudinal sides along a longitudinal direction X and two shorter transverse sides along a lateral direction Y substantially perpendicular to the longitudinal direction X. Accordingly, the puzzle board 1 defines an XY coordinate surface.

The puzzle board 1 comprises six board units 10 arranged in a 2×3 layout. The puzzle board 1 has six drawer cavities 15 and six puzzle drawers 14 received in the corresponding drawer cavities 15. The storage capacity of the puzzle drawers 14 varies according to the different sizes of the puzzle pieces 200. The drawer cavities 15 comprise four lateral cavities 151 arranged in the lateral direction Y and two longitudinal cavities 152 arranged in the longitudinal direction X. The four lateral cavities 151 comprise a first lateral cavity 1511, a second lateral cavity 1512, a third lateral cavity 1513, and a fourth lateral cavity 1514. The two longitudinal cavities 152 comprise a first longitudinal cavity 1521 and a second longitudinal cavity 1522.

The puzzle plate 11 of each board unit 10 has an upper face 111 for placing the puzzle pieces 200 thereon and a back side 112 opposite the upper face 111. The upper face 111 serves as a substantially flat surface used as a puzzle operating area, while the reinforcing wall 12 extends integrally from the back side 112 of the puzzle plate 11. The drawer cavity 15 is located under the back side 112 of the puzzle plate 11. The reinforcing wall 12 is substantially perpendicular to the back side 112 of the puzzle plate 11.

Each board unit 10 further comprises a plurality of reinforcing portions 110 arranged on the back side 112, designed to increase the strength of the puzzle plate 11 and enhance its load-bearing capacity for the puzzle pieces 200. The height of the reinforcing portions 110 is less than the height of the reinforcing wall 12. The reinforcing portions 110 are located within the drawer cavity 15.

The reinforcing wall 12 comprises an extending portion 121 that extends integrally from the back side 112 of the puzzle plate 11, and a plurality of holders 122 that bend and extend integrally from the extending portion 121. The holders 122 protrude from a bottom of the extending portion 121 into the corresponding drawer cavity 15, supporting the corresponding puzzle drawer 14 and thereby preventing it from falling out of the drawer cavity 15.

The connecting assembly 13 is used to connect the two adjacent board units 10, positioned on the exterior of the reinforcing wall 12, and connected to the reinforcing wall 12. For any given board unit 10, the position and quantity of the connecting assembly 13 are determined by the location and number of the adjacent board units 10.

In this embodiment, the puzzle table 100 comprises six board units 10 arranged in a 2×3 layout. Depending on their positions, the board units 10 can be classified as corner units 10A and connecting units 10B. The corner units 10A are located at the corners of the puzzle table 100, while the connecting units 10B are positioned along the edges. Each corner unit 10A connects to two other units, whereas each connecting unit 10B connects to three other units. In other embodiments, the board units 10 may also include middle units situated in the center of the puzzle table 100. Each middle unit connects to four other units, which means that the connecting assembly 13 needs to be set up on all four sides of each middle unit.

The reinforcing wall 12 not only serves as a mounting position for the connecting assembly 13 but may also be used to install other structural components of the board units 10. For instance, to enhance the stability of the board units 10, a side wall 17 may be installed on the outside of the reinforcing wall 12 and spaced apart from it. The side wall 17 is connected to the reinforcing wall 12 via a plurality of reinforcing plates 18, which are also integrally secured to the back side 112 of the puzzle plate 11. Together, the side wall 17, the reinforcing wall 12, and the puzzle plate 11 form a side space 123 in which the reinforcing plates 18 are arranged. The side wall 17, the reinforcing wall 12, and the reinforcing plates 18 are integrally secured to the puzzle plate 11 to form a one-piece structure. In an alternative embodiment, the reinforcing plates may be omitted. This provides support to the puzzle plate 11 and increases the structural strength of its edges, thereby preventing collapse at the edges. The side wall 17 is positioned on the sides of the corner units 10A where the connecting assembly 13 is not required; the side wall 17 may also be placed on the sides of the connecting units 10B where the connecting assembly 13 is unnecessary. In this case, it will not be possible to install pull-out drawers below the puzzle plate 11.

In this embodiment, the puzzle board 1 comprises four corner units 10A and two connecting units 10B. To clarify the content of this embodiment, the four corner units 10A are sequentially labeled in a clockwise direction as a first corner part 10A1, a second corner part 10A2, a third corner part 10A3, and a fourth corner part 10A4. The two connecting units 10B are respectively labeled as a first connecting part 10B1 and a second connecting part 10B2. Among them, the first corner part 10A1 is connected to the fourth corner part 10A4 and the first connecting part 10B1; the second corner part 10A2 is connected to the first connecting part 10B1 and the third corner part 10A3; the third corner part 10A3 is connected to the second corner part 10A2 and the second connecting part 10B2; the fourth corner part 10A4 is connected to the second connecting part 10B2 and the first corner part 10A1. Additionally, the first connecting part 10B1 and the second connecting part 10B2 remain interconnected. The structures of the first corner part 10A1 and the third corner part 10A3 are identical and exhibit central symmetry, while the structures of the second corner part 10A2 and the fourth corner part 10A4 are also identical and exhibit central symmetry. Furthermore, the structures of the first connecting part 10B1 and the second connecting part 10B2 are the same and mutually symmetrical.

The four lateral cavities 151 are respectively arranged on the four corner units 10A, while the two longitudinal cavities 152 are arranged on the two connecting units 10B. Specifically, the first lateral cavity 1511 is formed on the first corner part 10A1, the second lateral cavity 1512 is formed on the second corner part 10A2, the third lateral cavity 1513 is formed on the third corner part 10A3, and the fourth lateral cavity 1514 is formed on the fourth corner part 10A4. The first longitudinal cavity 1521 is formed on the first connecting part 10B1, and the second longitudinal cavity 1522 is formed on the second connecting part 10B2.

According to the different connection structures, the connecting assembly 13 comprises an inserting assembly 130 and a receiving assembly 140. The inserting assembly 130 is designed to be inserted into the receiving assembly 140 to achieve connection and fastening. Therefore, in two adjacent board units 10, one board unit 10 is equipped with the inserting assembly 130, while the other is equipped with the receiving assembly 140 to match the inserting assembly 130. Each of the inserting assembly 130 and the receiving assembly 140 is integrally formed on and connected to a corresponding board unit 10 as a one-piece structure. Apart from the puzzle drawer 14, each board unit 10 with the corresponding inserting assembly 130 or receiving assembly 140 is a one-piece structure. The term “one-piece structure” refers to an integral body formed by the puzzle plate 11, the reinforcing wall 12, the connecting assembly 13, and the reinforcing portions 110, which possesses good structural integrity without any splicing transitional areas between the connected components. The side wall 17 and the reinforcing plates 18 are also integrally formed with the puzzle plate 11. When the inserting assembly 130 and the receiving assembly 140 are inserted into each other, the two adjacent board units 10 are spliced with each other, and upper faces 111 of puzzle plates 11 of the two adjacent board units 10 are substantially flush with each other.

The inserting assembly 130 protrudes outward relative to the reinforcing wall 12, while the receiving assembly 140 may either protrude outward or be recessed inward relative to the reinforcing wall 12. When the receiving assembly 140 is positioned on the corner units 10A, it protrudes outward relative to the reinforcing wall 12. At this point, part of the structure of the receiving assembly 140 is flush with the upper face 111 of the puzzle plate 11, serving as a part of the puzzle operating area. Conversely, when the receiving assembly 140 is positioned on the connecting units 10B, it is recessed inward relative to the reinforcing wall 12. In this case, part of the structure of the receiving assembly 140 forms an integral connection with the back side 112 of the puzzle plate 11.

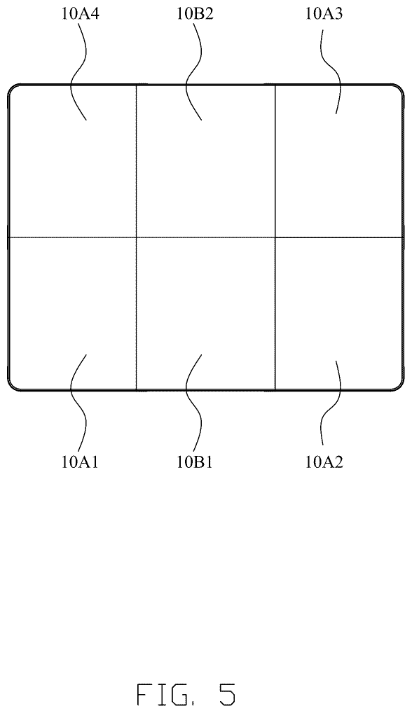

As shown in FIGS. 5-12, two inserting assemblies 130 are connected to the reinforcing wall 12 of the first corner part 10A1 towards the first connecting part 10B1, while two matching receiving assemblies 140 are connected to the reinforcing wall 12 of the first connecting part 10B1 towards the first corner part 10A1. Similarly, two inserting assemblies 130 are connected to the reinforcing wall 12 of the second corner part 10A2 towards the first connecting part 10B1, while two matching receiving assemblies 140 are connected to the reinforcing wall 12 of the first connecting part 10B1 towards the second corner part 10A2. For the third corner part 10A3, two inserting assemblies 130 are connected to the reinforcing wall 12 towards the second connecting part 10B2, and two corresponding receiving assemblies 140 are connected to the reinforcing wall 12 of the second connecting part 10B2 towards the third corner part 10A3. Likewise, for the fourth corner part 10A4, two inserting assemblies 130 are connected to the reinforcing wall 12 towards the second connecting part 10B2, with two corresponding receiving assemblies 140 connected to the reinforcing wall 12 of the second connecting part 10B2 towards the fourth corner part 10A4. Additionally, two receiving assemblies 140 are connected to the reinforcing wall 12 of the first corner part 10A1 towards the fourth corner part 10A4, while two matching inserting assemblies 130 are connected to the reinforcing wall 12 of the fourth corner part 10A4 towards the first corner part 10A1. For the third corner part 10A3, two receiving assemblies 140 are again connected to the reinforcing wall 12 towards the second corner part 10A2, with two matching inserting assemblies 130 connected to the reinforcing wall 12 of the second corner part 10A2 towards the third corner part 10A3. Finally, one inserting assembly 130 and one receiving assembly 140 are connected to the reinforcing wall 12 of the first connecting part 10B1, leading towards the second connecting part 10B2. Meanwhile, another matching receiving assembly 140 and inserting assembly 130 are connected to the reinforcing wall 12 of the second connecting part 10B2, facing the first connecting part 10B1.

The extending portion 121 of the reinforcing wall 12 in each board unit 10 comprises a plurality of interconnected extending walls 124. The extending walls 124 of each board unit 10 comprise a first extending segment 1241 and a second extending segment 1242. The first extending segment 1241 is a one-piece structure that integrally extends from the back side 112 of the puzzle plate 11. The second extending segment 1242 comprises a drawer wall 125, an engaging wall 126 opposite the drawer wall 125, and a hollow space 127 formed by the drawer wall 125, the engaging wall 126, and a part of the puzzle plate 11. Both the drawer wall 125 and the engaging wall 126 integrally extend from the back side 112 of the puzzle plate 11 and are substantially parallel to each other. To enhance the stability of the interconnection between adjacent board units 10, the second extending segment 1242 optionally further comprises a plurality of connecting walls 128 connecting the drawer wall 125 and the engaging wall 126. The holders 122 are integrally connected to the first extending segment 1241 and/or the second extending segment 1242. Thicknesses of the holders 122, the first extending segment 1241, and the drawer wall 125 are substantially the same. If the inserting assembly 130 and the receiving assembly 140 connect with the second extending segment 1242, they will connect with the engaging wall 126 and extend away from the drawer wall 125.

The extending portion 121 of each board unit 10 comprises at least one limiting bar 1211, and the puzzle drawer 14 comprises at least one limiting groove 104 that matches the limiting bar 1211, ensuring that the puzzle drawer 14 is firmly fixed in the drawer cavity 15. Preferably, the extending portion 121 further comprises at least one limiting opening 1212 located near the corresponding limiting bar 1211, which provides the limiting bar 1211 with good elasticity. This allows the puzzle drawer 14 to be easily and smoothly actuated to slide in and out of the drawer cavity 15 through the drawer opening 16.

In order to achieve an inserting function, the inserting assembly 130 comprises an inserting portion 131 and a hollow groove 1310 formed in the inserting portion 131. The receiving assembly 140 comprises a receiving wall 141 and a receiving slot 142 surrounded by the receiving wall 141. The inserting portion 131 is capable of being accommodated within the receiving slot 142 and abutting against the receiving wall 141. The inserting assembly 130 may be either a continuous integral structure or a segmented structure with intervals. An inserting direction of the inserting assembly 130 and the receiving assembly 140 is substantially parallel to an extending direction of the upper face 111 of the puzzle plate 11. The inserting direction is substantially parallel to the XY coordinate surface.

In this embodiment, the receiving assembly 140 on the first connecting part 10B1, which connects to the inserting assembly 130 of the second connecting part 10B2, is recessed inward from the reinforcing wall 12. This means that the receiving assembly 140 of the first connecting part 10B1 is set back toward the first longitudinal cavity 1521. Similarly, the receiving assembly 140 on the second connecting part 10B2, which connects to the inserting assembly 130 of the first connecting part 10B1, is also recessed inward from the reinforcing wall 12, indicating that the receiving assembly 140 of the second connecting part 10B2 is positioned toward the second longitudinal cavity 1522. The receiving assembly 140 and the inserting assembly 130 on the corner units 10A protrude outward from the reinforcing wall 12, meaning that the receiving assembly 140 and the inserting assembly 130 of the corner units 10A extend in the direction away from the lateral cavities 151.

The inserting direction between the inserting assembly 140 and the receiving assembly 130 is substantially parallel to an extending direction of the drawer cavity 15 in at least one of the two adjacent board units 10. When the first connecting part 10B1 and the second connecting part 10B2 are inserted together, the inserting direction between the inserting assembly 130 and the receiving assembly 140 is substantially parallel to the extending direction of the first longitudinal cavity 1521 of the first connecting part 10B1. Additionally, the inserting direction is also substantially parallel to the extending direction of the second longitudinal cavity 1522 of the second connecting part 10B2. When each corner unit 10A and the corresponding connecting unit 10B are inserted together, the inserting direction between the inserting assembly 130 and the receiving assembly 140 is substantially parallel to the extending direction of the drawer cavity, which corresponds to the longitudinal cavity 152 of the connecting unit 10B. At this time, the inserting direction between the inserting assembly 130 and the receiving assembly 140 is substantially perpendicular to the extending direction of the lateral cavity 151 of each corner unit 10A. When two adjacent corner units 10A are inserted together, the inserting direction between the inserting assembly 130 and the receiving assembly 140 is substantially parallel to the extending direction of the drawer cavity 15, specifically a corresponding lateral cavity 151, in at least one of the two adjacent corner units 10A.

The first corner part 10A1 and the second corner part 10A2 are slidingly inserted on opposite sides of the first connecting part 10B1 in the inserting direction, which is substantially parallel to the extending direction of the first longitudinal cavity 1521. The third corner part 10A3 and the fourth corner part 10A4 are slidingly inserted on opposite sides of the second connecting part 10B2 in the inserting direction, which is substantially parallel to the extending direction of the second longitudinal cavity 1522.

Additionally, the first corner part 10A1 is slidingly inserted onto the fourth corner part 10A4 in the inserting direction, which is substantially parallel to the extending direction of either the first lateral cavity 1511 or the fourth lateral cavity 1514. The third corner part 10A3 is slidingly inserted onto the second corner part 10A2 in the inserting direction, which is substantially parallel to the extending direction of either the second lateral cavity 1512 or the third lateral cavity 1513.

An assembly sequence for puzzle board 1 has many variations, one of which is as follow Step 1: Assemble the first corner part 10A1 and the fourth corner part 10A4; then assemble the second corner part 10A2 and the third corner part 10A3. Step 2: Align and insert the receiving assembly 140 on both sides of the first connecting part 10B1 with the inserting assembly 130 on the first corner part 10A1 and the second corner part 10A2, completing the assembly of the first connecting part 10B1 with the first corner part 10A1 and the second corner part 10A2. Step 3: Align and insert the receiving assembly 140 on both sides of the second connecting part 10B2 with the inserting assembly 130 on the third corner part 10A3 and the fourth corner part 10A4, completing the assembly of the second connecting part 10B2 with the third corner part 10A3 and the fourth corner part 10A4. Then, align and tighten the inserting assembly 130 and the receiving assembly 140 on the first connecting part 10B1 and the second connecting part 10B2 to complete the assembly.

The arrangement of hollow groove 1310 increases an elasticity of the inserting portion 131. The inserting portion 131 and the receiving wall 141 may be selected for an interference fit. During the insertion process, the receiving wall 141 compresses the inserting portion 131, causing the inserting portion 131 to elastically deform toward the hollow groove 1310. After complete insertion, the inserting portion 131 exerts an outward reverse elastic force on the receiving wall 141, causing the inserting portion 131 and the receiving wall 141 to fit closely together, thereby enhancing connection stability.

In this embodiment, two specific inserting methods are provided. The connection between the two connecting units 10B is achieved through a face-to-face inserting method, while a sliding inserting method is used for the connection between any other two adjacent units.

Face-to-Face Inserting Method: This inserting method is applied to the connection between the first connecting part 10B1 and the second connecting part 10B2. Align the inserting portion 131 with the receiving slot 142, and then directly insert the inserting portion 131 into the receiving slot 142. The inserting portion 131 and the receiving slot 142 utilize a straight pull-in method, allowing for a quick and easy connection.

Sliding inserting Method: This inserting method is applied in the connection between two adjacent corner units 10A or in the connection between the corner units 10A and the connecting units 10B. At least one end of the receiving assembly 140 is provided with an inserting opening 150 along the inserting direction, allowing the inserting portion 131 to be inserted through the inserting opening 150 of the receiving assembly 140. This enables the inserting portion 131 to slide along the receiving slot 142 in the inserting direction, away from the inserting opening 150, to a predetermined position.

When using the sliding inserting method, the structure of each receiving assembly 140 is as follows: The receiving wall 141 comprises a first receiving segment 1411 and a second receiving segment 1412 integrally connected with the first receiving segment 1411. The first receiving segment 1411 is a one-piece structure and comprises a top plate 143 that is flush with the upper face 111 of the puzzle plate 11 and a bottom plate 144 opposite to the top plate 143. The second receiving segment 1412 comprises a first baffle 145 extending from the top plate 143 towards the bottom plate 144 and a second baffle 146 extending from the bottom plate 144 towards the top plate 143. The first baffle 145 and the reinforcing wall 12 are located on opposite sides of the top plate 143, while the second baffle 146 and the reinforcing wall 12 are located on opposite sides of the bottom plate 144. Both the top plate 143 and the bottom plate 144 are integrally connected to the reinforcing wall 12. The first receiving segment 1411 further comprises a first receiving slot 147 formed the reinforcing wall 12, the top plate 143, and the bottom plate 144. The second receiving segment 1412 is a one-piece structure and comprises a second receiving slot 148 formed by the first baffle 145 and the second baffle 146. The first receiving slot 147 is in communication with the second receiving slot 148 for forming the receiving slot 142. The first receiving slot 147 is closer to the drawer cavity 15 than the second receiving slot 148. Optionally, the first receiving segment 1411 and the second receiving segment 1412 may also be configured separately and bonded together using adhesives or similar materials.

To match the structures of the first receiving slot 147 and the second receiving slot 148, the inserting portion 131 correspondingly comprises a first inserting segment 1311 and a second inserting segment 1321 integrally connected with the first inserting segment 1311. The first inserting segment 1311 is completely inserted into the first receiving slot 147, while the second inserting segment 1321 is completely inserted into the second receiving slot 148. The cross-sectional area of the second inserting segment 1321 is smaller than that of the first inserting segment 1311. Optionally, the first inserting segment 1311 and the second inserting segment 1321 may also be configured separately and bonded together using adhesives or similar materials.

The first inserting segment 1311 is a one-piece structure and comprises an upper plate 1312, a lower plate 1313 that is substantially parallel to and spaced from the upper plate 1312, and inserting plates 1314 positioned at both ends of the upper plate 1312 to connect the upper plate 1312 with the lower plate 1313. There is also a first inserting groove 1315 enclosed by the upper plate 1312, the lower plate 1313, and the inserting plates 1314.

The second inserting segment 1321 is a one-piece structure and comprises a fixing portion 1320 integrally extending from the reinforcing wall 12 away from the cavity 15, a first protruding portion 1323 integrally extending from the fixing portion 1320 towards the puzzle plate 11, and a second protruding portion 1324 integrally extending from the fixing portion 1320 away from the puzzle plate 11. The fixing portion 1320 and the first protruding portion 1323 form a first engaging space 1325 for receiving the first baffle 145, while the fixing portion 1320 and the second protruding portion 1324 form a second engaging space 1326 for receiving the second baffle 146. The second inserting segment 1321 further comprises a second inserting groove 1327 formed on the fixing portion 1320 and communicated with the first inserting groove 1315. The first inserting groove 1315 and the second inserting groove 1327 form the hollow groove 1310 to facilitate the receiving assembly 140 and the inserting assembly 130 to be inserted together. The first protruding portion 1323 is integrally connected to the upper plate 1312 of the first inserting segment 1311. The second protruding portion 1324 is integrally connected to the lower plate 1313 of the first inserting segment 1311.

When the two adjacent board units 10 are assembled, the upper plate 1312 of the first inserting segment 1311 is engaged with the top plate 143 of the first receiving segment 1411, while the bottom plate 144 of the first receiving segment 1411 is engaged with the lower plate 1313 of the first inserting segment 1311. The first protruding portion 1323 is engaged with the first baffle 145 and is received into the first receiving slot 147. The second protruding portion 1324 is engaged with the second baffle 146 and is also received into the first receiving slot 147. Additionally, the fixing portion 1320 is received into the second receiving slot 148.

The rotating device 2 is detachably coupled to the puzzle board 1. The rotating device 2 may be secured to two or more board units 10 simultaneously, or it may be fixed to a single board unit 10. The rotating device 2 features a hollow annular structure, comprising a first frame 21 that is coupled to the puzzle board 1, a second frame 22 that is coupled to the first frame 21 and mounted on the playing surface 20, and a rotating unit 23 that can rotate relative to either the first frame 21 or the second frame 22. This arrangement allows the puzzle board 1 to slide or rotate on the playing surface 20 in various directions under the driving force of the rotating device 2. The puzzle board 1 is capable of being self-rotated 360° on the playing surface 20 through the rotational movement of the rotating device 2.

The rotating device 2 further comprises a plurality of coupling members 25 extending from the first frame 21 to detachably couple with the puzzle board 1. Preferably, the coupling members 25 are integrally formed with the first frame 21. Alternatively, the coupling members 25 can be a two-piece structure that is separate from the first frame 21. Each of the coupling members 25 has a coupling slot 251 formed therein to detachably couple with the puzzle board 1 by inserting screws 252 through the coupling slot 251 into the puzzle board 1. It is worth mentioning that a plurality of screw holes 1441 are formed in the bottom plate 144 of the puzzle board 1, such that the screws 252 can engage with the screw holes 1441 through the coupling slot 251 to couple the rotating device 2 with the puzzle board 1.

To enhance the stability of the connection between the receiving assembly 140 and the inserting assembly 130, the receiving assembly 140 comprises a locking slot 1442, while the inserting assembly 130 comprises a locking bar 1316 securely engaged with the locking slot 1442. When the inserting assembly 130 is inserted into the receiving assembly 140, the locking bar 1316 interlocks with the locking slot 1442, thereby providing additional resistance against the inadvertent disengagement of the inserting assembly 130 from the receiving assembly 140. The locking slot 1442 is seamlessly integrated into the bottom plate 144, with the locking bar 1316 extending outward from the lower plate 1313. The locking slot 1442 may be strategically positioned at various locations on the receiving assembly 140, while the locking bar 1316 can likewise be adjusted to different positions on the inserting assembly 130. Additionally, the locking slot can also be integrated into the inserting assembly, with the locking bar located on the receiving assembly. The cooperative function of the locking slot 1442 and the locking bar 1316 significantly enhances the stability of the connection between the receiving assembly 140 and the inserting assembly 130, thereby ensuring accurate alignment during the insertion process.

The receiving assembly 140 has the first receiving slot 147 and the second receiving slot 148 communicated with the first receiving slot 147. The first inserting segment 1311 is completely inserted into the first receiving slot 147, while the second inserting segment 1321 is completely inserted into the second receiving slot 148, Thus, the puzzle table 100 employs a dual-insertion structure to enhance insertion stability and prevent the inserting portion 131 from detaching from the receiving slot 142.

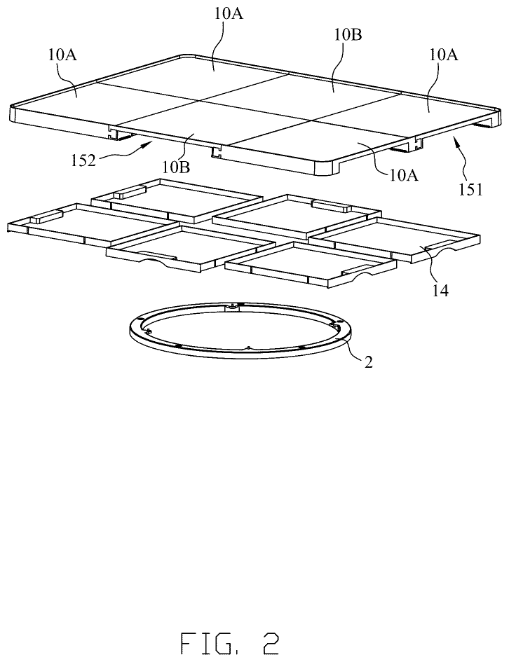

As shown in FIGS. 2-4, The rotating device 2 is securely positioned at the central region of the puzzle board 1, enhancing stability in the center of the puzzle plate 11 and minimizing the likelihood of disassembly. In contrast, the edge positions of the puzzle plate 11 do not offer this same level of support; as a result, while the central section may remain flat, the edges may sag, become loose, or even disassemble, which can affect the overall flatness and integrity of the puzzle plate 11. The dual-insertion structure effectively reinforces the integrity of the puzzle table, ensuring that adjacent board units 10 remain firmly connected after the overall assembly process.

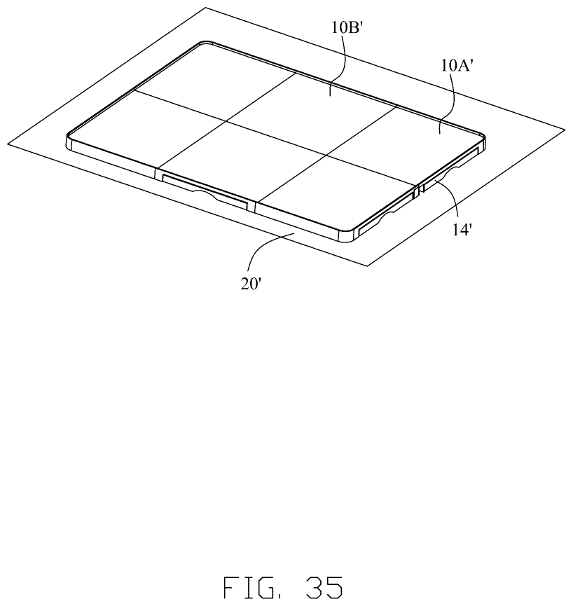

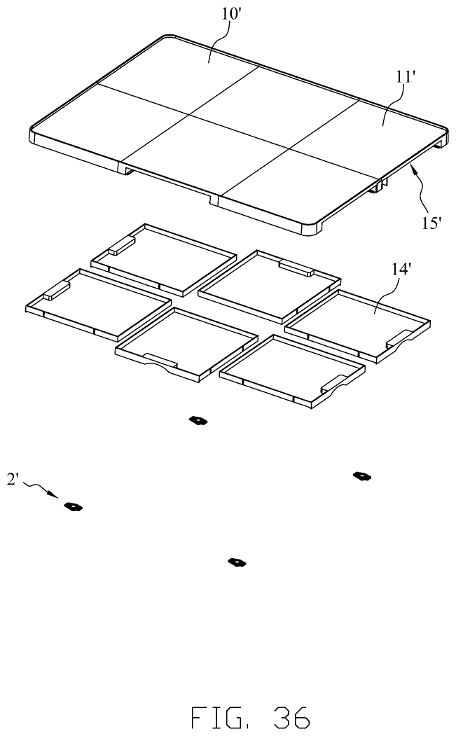

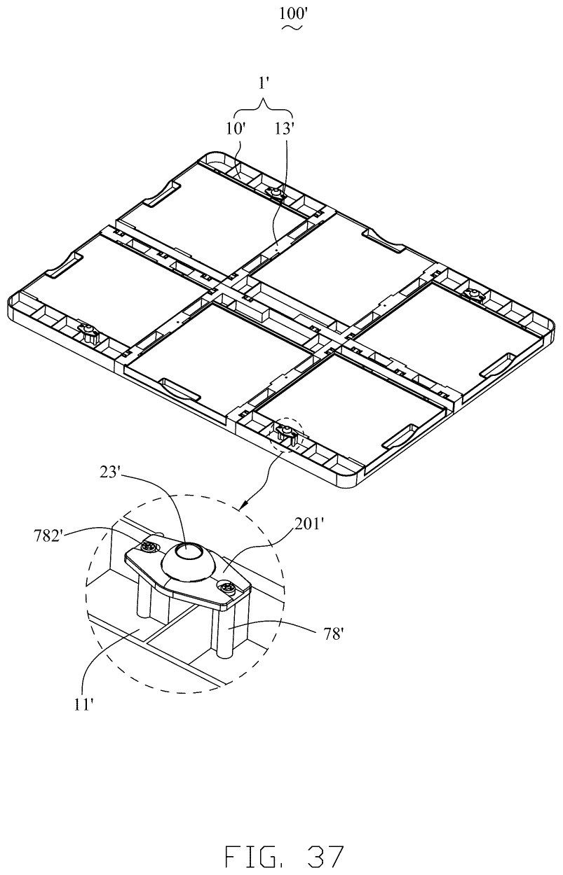

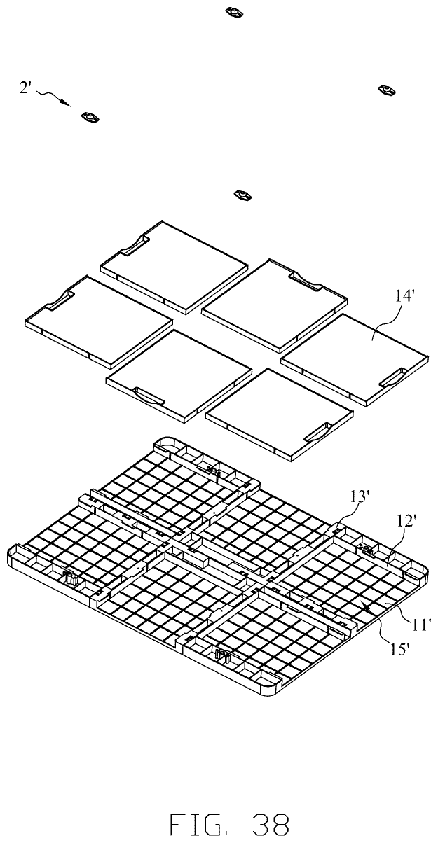

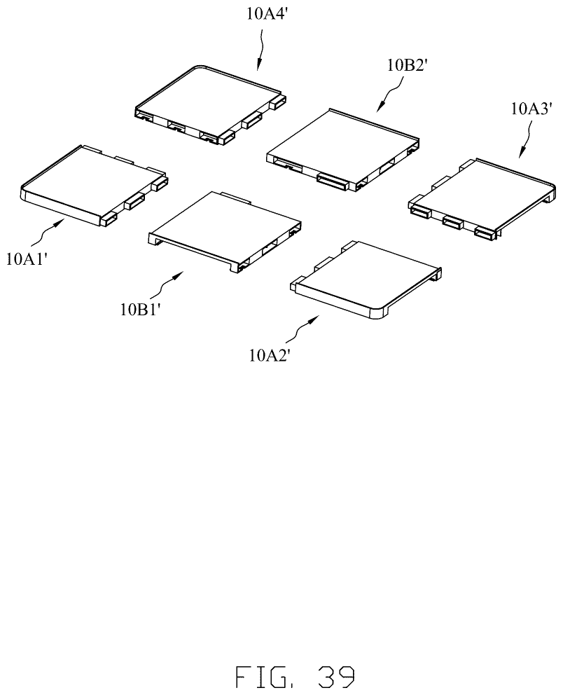

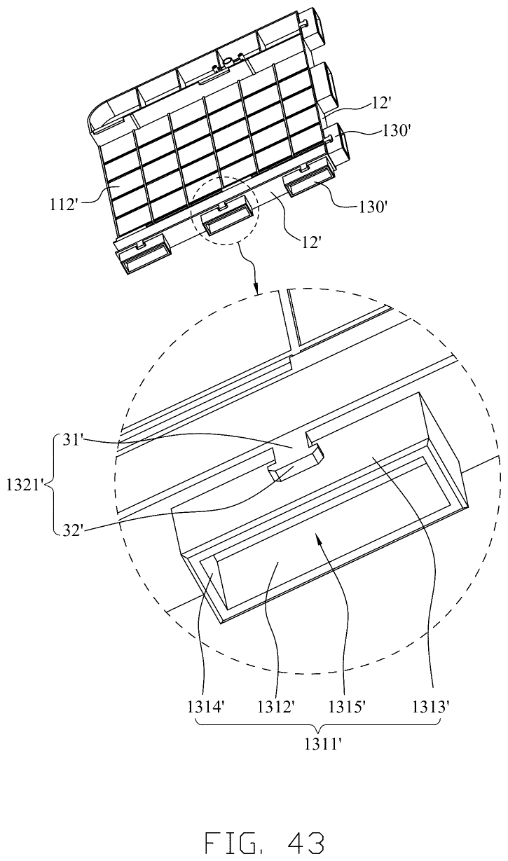

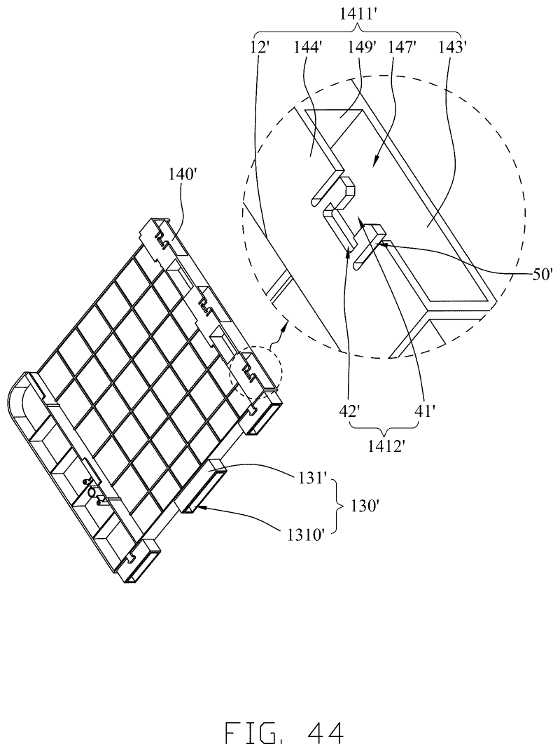

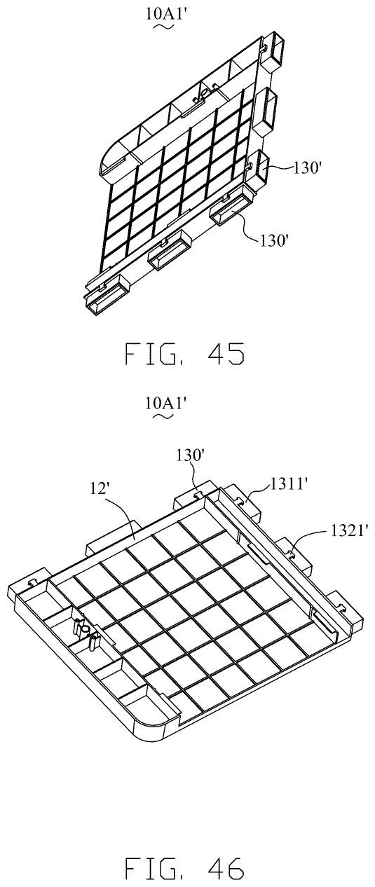

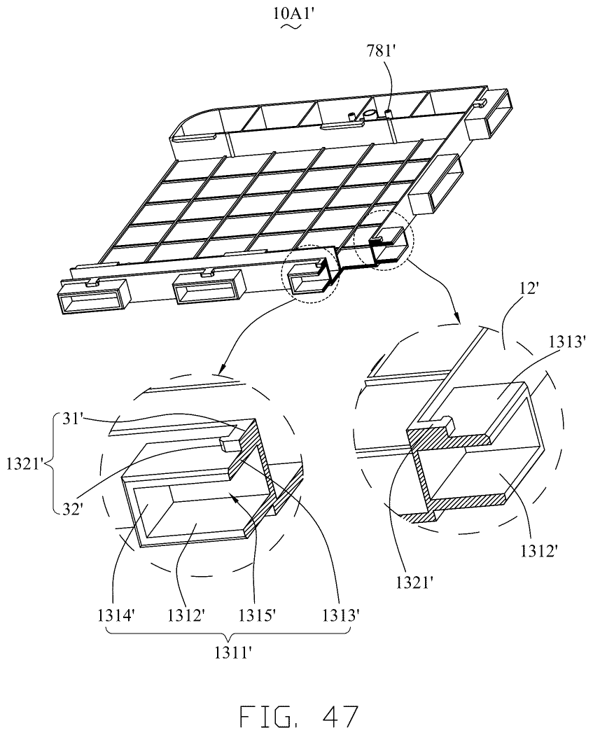

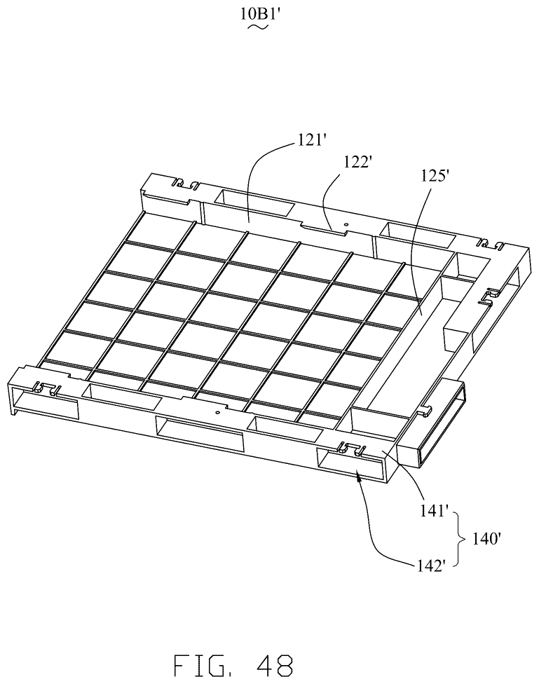

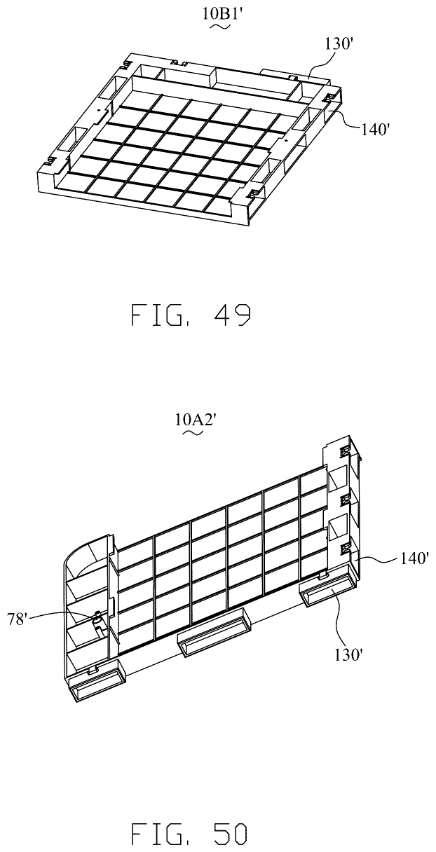

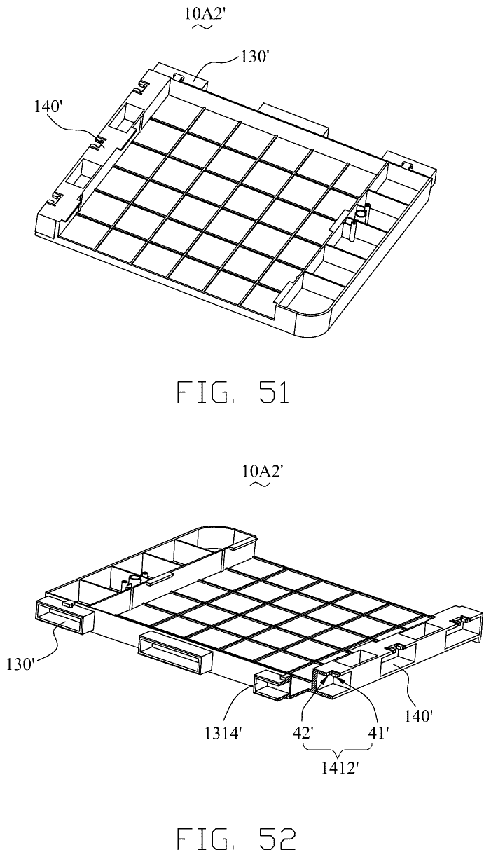

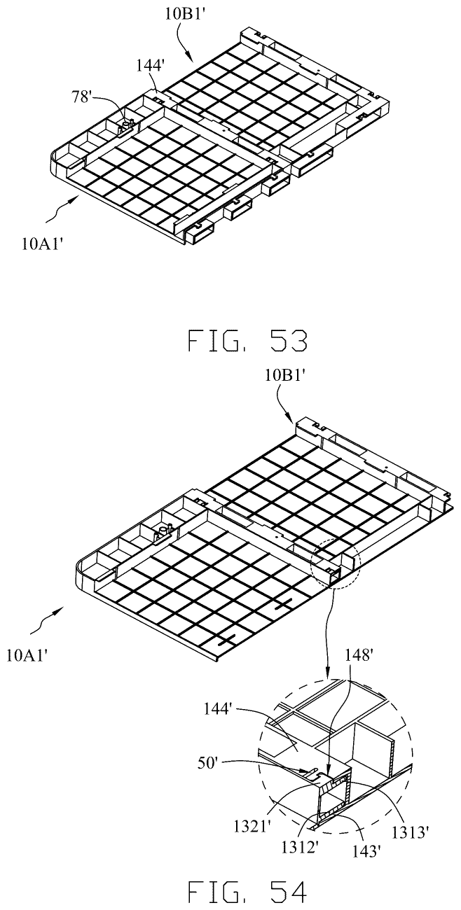

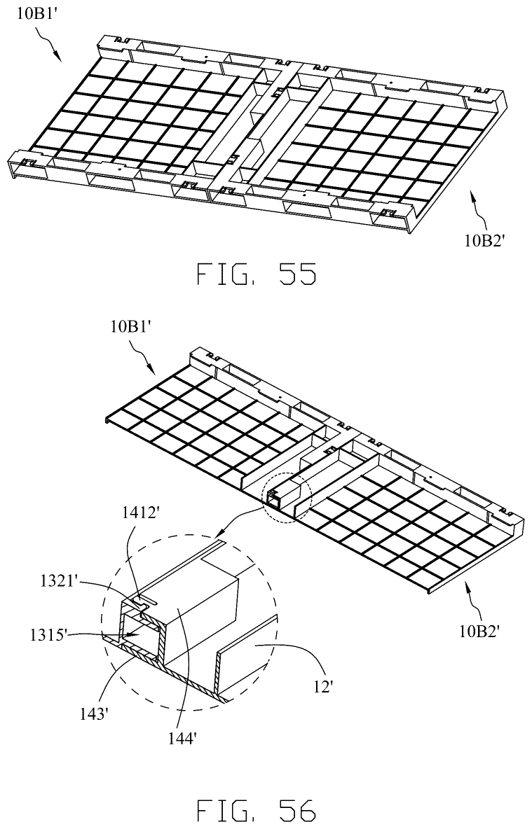

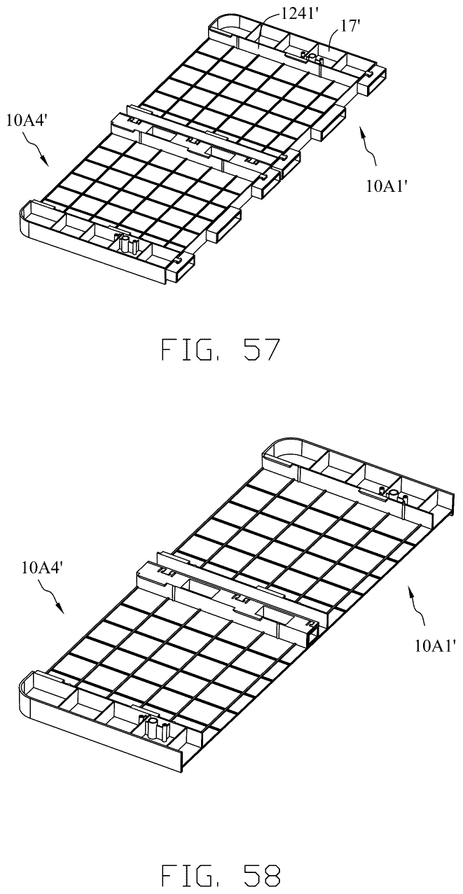

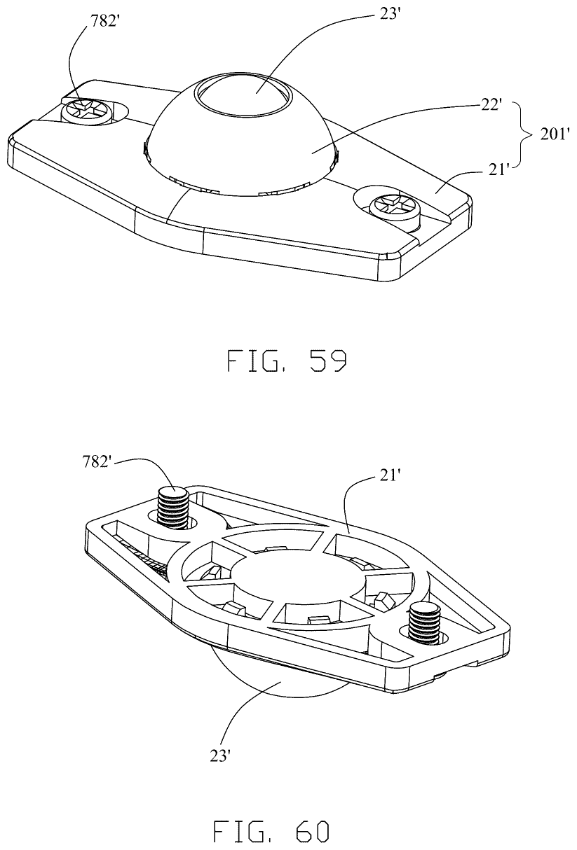

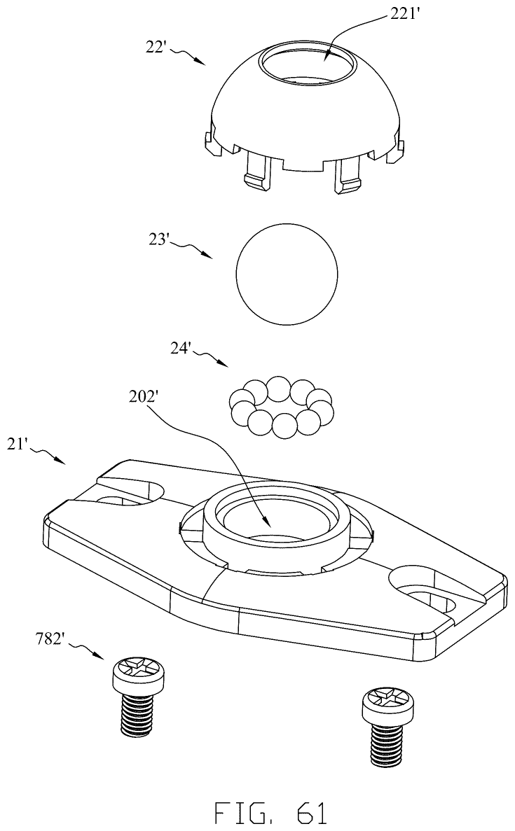

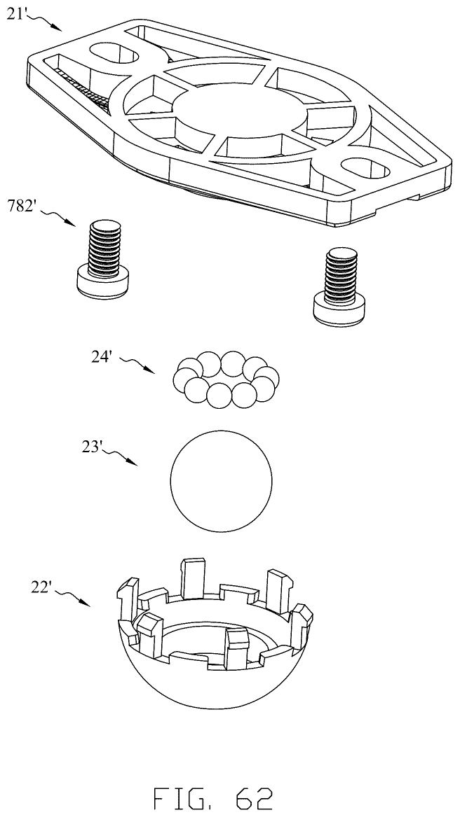

FIGS. 35-62 show puzzle table 100′ of a second embodiment of the present disclosure. The puzzle table 100′ comprises a puzzle board 1′ and at least one rotating device 2′ located below the puzzle board 1′ and connected to the puzzle board 1′. The puzzle board 1′ comprises at least two board units 10′ and at least one connecting assembly 13′ configured to detachably connect two adjacent board units of the at least two board units 10′. Each board unit 10′ comprises a puzzle plate 11′, a reinforcing wall 12′ supporting the puzzle plate 11′, a drawer cavity 15′ formed by the puzzle plate 11′ and the reinforcing wall 12′, and a puzzle drawer 14′ installed within the drawer cavity 15′. Each connecting assembly 13′ comprises an inserting assembly 130′ and a receiving assembly 140′. The inserting assembly 130′ is designed to be inserted into the receiving assembly 140′ to achieve connection and fastening. Therefore, in the two adjacent board units 10′, one board unit 10′ is equipped with the inserting assembly 130′, while the other is equipped with the receiving assembly 140′ to match the inserting assembly 130′. The puzzle plate 11′ of each board unit 10′ has an upper face 111′ for placing puzzle pieces 200′ thereon and a back side 112′ opposite the upper face 111′.

Depending on their positions, the board units 10′ can be classified as corner units 10A′ and connecting units 10B′. The corner units 10A′ are sequentially labeled in a clockwise direction as a first corner part 10A1′, a second corner part 10A2′, a third corner part 10A3′, and a fourth corner part 10A4′. The connecting units 10B′ are respectively labeled as a first connecting part 10B1′ and a second connecting part 10B2′. The structures of the first corner part 10A1′ and the third corner part 10A3′ are identical, while the structures of the second corner part 10A2′ and the fourth corner part 10A4′ are also identical. Furthermore, the structures of the first connecting part 10B1′ and the second connecting part 10B2′ are identical.

The inserting assembly 130′ comprises an inserting portion 131′ extending along an inserting direction and a hollow groove 1310′ formed in the inserting portion 131′. The receiving assembly 140′ comprises a receiving wall 141′ and a receiving slot 142′ recessed along the inserting direction and surrounded by the receiving wall 141′.

The second embodiment is similar to the first embodiment of the present disclosure, except for the following differences: (1) The structure of the inserting assembly 130′ is different. (2) A face-to-face inserting method is employed between any two corner units 10A′. In the inserting process, the inserting portion 131′ of one corner unit 10A′ is aligned with the receiving slot 142′ of another corner unit 10A′, and then the two corner units 10A′ are driven to move towards each other. Alternatively, one corner unit 10A′ may be kept stationary while the other corner unit 10A′ is moved towards it, allowing the inserting portion 131′ of one corner unit 10A′ to be directly inserted into the receiving slot 142′ of the other corner unit 10A′ under an inserting force. This inserting method is simple to operate and allows for the rapid connection of two adjacent corner units 10′. (3) The structure of the rotating device 2′ is different.

The inserting portion 131′ of each board unit 10′ is a one-piece structure and comprises a first inserting segment 1311′ and a second inserting segment 1321′ integrally connected to the first inserting segment 1311′. The first inserting segment 1311′ extends in the inserting direction and forms a closed ring shape. The first inserting segment 1311′ comprises an upper plate 1312′, a lower plate 1313′ that is substantially parallel to and spaced from the upper plate 1312′, and inserting plates 1314′ positioned at both ends of the upper plate 1312′ to connect the upper plate 1312′ with the lower plate 1313′. There is also an inserting groove 1315′ enclosed by the upper plate 1312′, the lower plate 1313′, and the inserting plates 1314′.

The inserting groove 1315′ enhances the elasticity of the first inserting segment 1311′. During the inserting process, the upper plate 1312′, the lower plate 1313′, and the inserting plates 1314′ are capable of experiencing elastic deformation due to the compressive forces exerted by the receiving assembly 140′. Upon complete insertion, the inserting portion 131′ exerts an outward reverse elastic force on the receiving wall 141′, facilitating a tight fit between the inserting portion 131′ and the receiving wall 141′, thereby improving the stability of the connection. The second inserting segment 1321′ integrally extends outward from the lower plate 1313′ in a direction away from the upper plate 1312′.

The receiving assembly 140′ is a one-piece structure and is positioned on the exterior of the reinforcing wall 12′. The receiving assembly 140′ comprises a top plate 143′ that is flush with the upper face 111′ of the puzzle plate 11′, a bottom plate 144′ located opposite the top plate 143′, and two side plates 149′ situated at either end of the top plate 143′ connecting the top plate 143′ to the bottom plate 144′. All components—the top plate 143′, bottom plate 144′, and side plates 149′—are affixed to the reinforcing wall 12′, thereby forming a first receiving slot 147′. Collectively, the reinforcing wall 12′, top plate 143′, bottom plate 144′, side plates 149′, and first receiving slot 147′ constitute a first receiving segment 1411′. Additionally, the receiving assembly 140′ comprises a second receiving segment 1412′ with a second receiving slot 148′, which is formed on the bottom plate 144′.

The first inserting segment 1311′is inserted into the first receiving slot 147′, while the second inserting segment 1321′ is inserted into the second receiving slot 148′. The first receiving slot 147′ and the second receiving slot 148′ are communicated, with the first receiving slot 147′ positioned between the puzzle plate 11′ and the second receiving slot 148′. The cross-sectional area of the second receiving slot 148′ is smaller than that of the first receiving slot 147′.

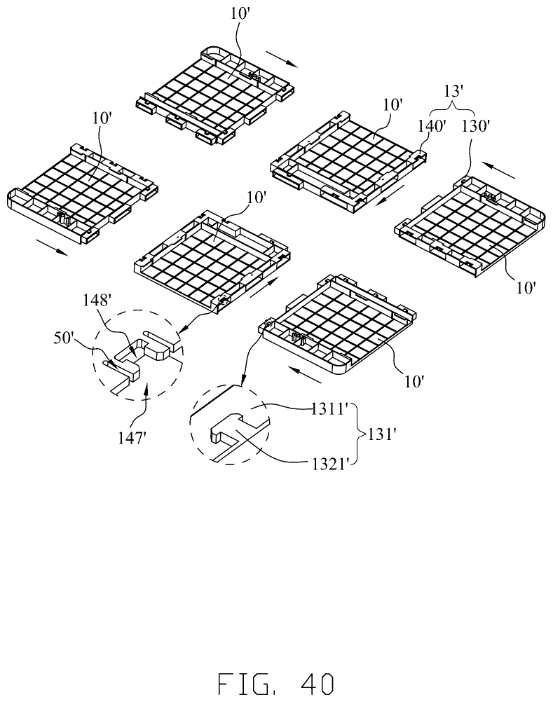

Referring to FIGS. 40-44, the second inserting segment 1321′ may be positioned on an outer surface of either the lower plate 1313′ or the inserting plates 1314′. When the second inserting segment 1321′ is placed on the lower plate 1313′, the corresponding second receiving segment 1412′ is positioned on the bottom plate 144′. When the second inserting segment 1321′is placed on the inserting plates 1314′, the corresponding second receiving segment 1412′ is positioned on the side plates 149′. The number of second inserting segment 1321′ may be one or more. For example, the second inserting segment 1321′ may be simultaneously positioned on the outer surfaces of the lower plate 1313′ and both inserting plates 1314′. In this embodiment, considering manufacturing costs and the difficulty of insertion, only one second inserting segment 1321′ is placed on the lower plate 1313′ of each inserting portion 131′.

The second inserting segment 1321′ has an overall T-shape, comprising a main body 31′ extending in the inserting direction and a locking portion 32′ positioned at one end of the main body 31′ and extending substantially perpendicular to the inserting direction. The ends of the locking portion 32′ protrude on both sides of the main body 31′. The end of the main body 31′ that is away from the locking portion 32′ is fixed to the reinforcing wall 12′, so that after the insertion is completed, the reinforcing wall 12′ may abut against the receiving assembly 140′, preventing any gaps between the two corner units 10′ and ensuring the structural integrity of a puzzle operating area.

The shape of the second receiving segment 1412′ matches the shape of the second inserting segment 1321′. The second receiving segment 1412′ comprises a main slot portion 41′ extending in the inserting direction and a sub-slot portion 42′ positioned at one end of the main slot portion 41′, extending substantially perpendicular to the inserting direction. The sub-slot portion 42′ is in communication with the main slot portion 41′. The main body 31′ is correspondingly inserted into the main slot portion 41′, while the locking portion 32′ is correspondingly inserted into the sub-slot portion 42′.

To reduce the difficulty of insertion, the second receiving segment 1412′ further comprises at least one avoidance slot 50′ located near the main slot portion 41′. The presence of the avoidance slot 50′ allows the main slot portion 41′ to gain a certain degree of flexibility. When the locking portion 32′ is inserted into the main slot portion 41′, the main slot portion 41′ undergoes elastic deformation toward the avoidance slot 50′, increasing the cross-sectional width of the main slot portion 41′ and providing the necessary space for the insertion of the locking portion 32′. Once the locking portion 32′ passes through the main slot portion 41′ and enters the sub-slot portion 42′, the main slot portion 41′ loses its squeezing force and rebounds to its original position.

The rotating device 2′ is detachably coupled to the puzzle board 1′. The number of rotating devices 2′ may be determined based on actual needs and may be one, two, or more than two. In this embodiment, the puzzle table 100′ comprises at least four rotating devices 2′, which are used for collectively supporting the puzzle board 1′ and allowing it to move smoothly along with the rotating devices 2′. The structures of the rotating devices 2′ are identical. This embodiment provides a detailed description of the specific structure of any one of the rotating devices. As shown in FIGS. 35-38 and 59-62, the rotating device 2′ comprises a case 201′, a first roller 23′ received in the case 201′, and second rollers 24′ also received in the case 201′ that are in constant contact with the first roller 23′. The case 201′ comprises a first frame 21′ and a second frame 22′ mounted on the first frame 21′ to form a receiving space 202′. The second frame 22′ has an opening 221′ that passes through it and communicates with the receiving space 202′. The second rollers 24′ are arranged in the receiving space 202′ and are configured to space the first roller 23′ apart from the first frame 21′ along a thickness direction of the rotating device 2′. The first roller 23′ is configured to rotate together with the second rollers 24′. The number of second rollers 24′ is greater than two, and they are arranged around the first roller 23′.

To secure the rotating devices 2′ onto the puzzle board 1′, the puzzle board 1′ comprises a number of connecting blocks 78′ that match the number of the rotating devices 2′. Each connecting block 78′ may extend integrally from the puzzle plate 11′. Alternatively, the connecting blocks 78′ may be arranged on the reinforcing wall 12′, or they may be positioned in any location on the puzzle board 1′. Each connecting block 78′ is provided with a threaded hole 781′, and the first frame 21′ is fixed to the connecting block 78′ using fasteners 782′ engaged with the threaded hole 781′, thereby allowing the rotating device 2′ to be securely attached to the puzzle board 1′.

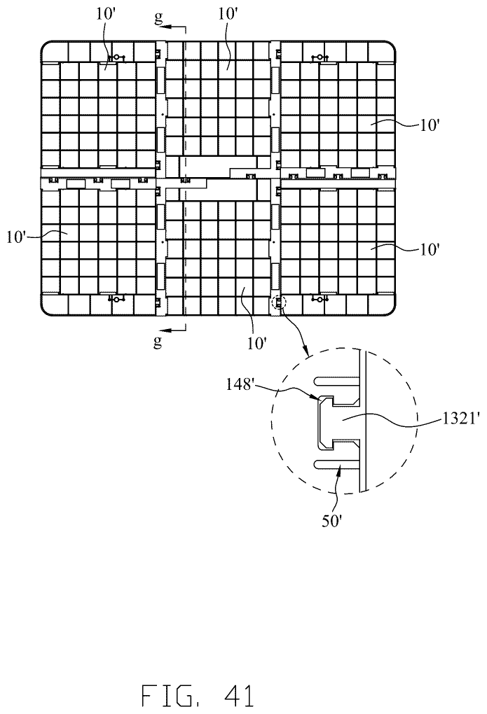

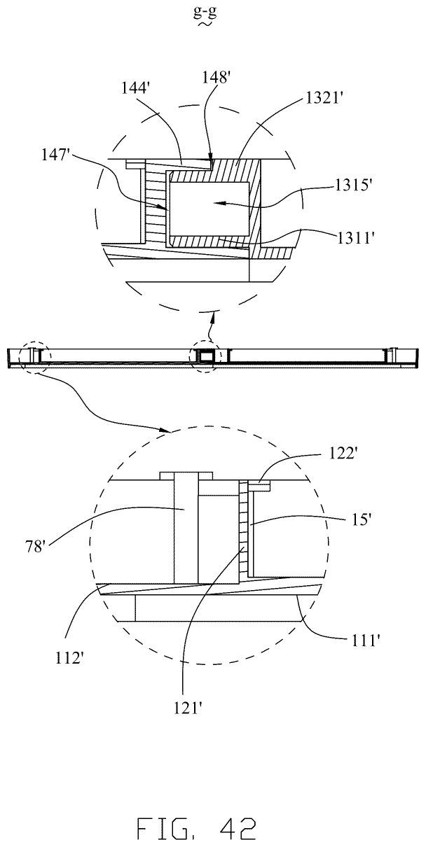

The reinforcing wall 12′ comprises an extending portion 121′ that extends integrally from the puzzle plate 11′ and a plurality of holders 122′ that bend and extend integrally from the extending portion 121′. As shown in FIG. 42, a height of the connecting block 78′ is greater than a height of the extending portion 121′ or the holders 122′. The connecting block 78′ is positioned further away from the puzzle plate 11′ compared to the reinforcing wall 12′, ensuring that the first roller 23′ protrudes from the puzzle board 1′ and can be placed on any playing surface 20′. Alternatively, all the holders 122′ may be connected into one unit. The height of the connecting block 78′ is lower than or equal to the height of the extending portion 121′, thereby ensuring sufficient clearance for the extension of the holders 122′. The rotating devices 2′ are directly fixed to the holders 122′.

The puzzle table 100′ employs a dual-insertion structure to enhance insertion stability and prevent the inserting portion 131′ from detaching from the receiving slot 142′.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. A puzzle table, comprises:
at least two board units, wherein each board unit comprises a puzzle plate for playing a plurality of puzzle pieces thereon;
at least one connecting assembly configured to connect two adjacent board units from the at least two board units;
wherein each connecting assembly comprises an inserting assembly and a receiving assembly, the inserting assembly is mounted on one of the two adjacent board units, the receiving assembly is mounted on the other board unit; and
wherein when the inserting assembly and the receiving assembly are engaged with each other, the two adjacent board units are spliced together, and upper faces of the puzzle plates of the two adjacent board units are substantially flush with each other.

2. The puzzle table as claimed in claim 1, wherein the inserting assembly and the receiving assembly are inserted into each other in an interference fit.

3. The puzzle table as claimed in claim 1, wherein an inserting direction between the inserting assembly and the receiving assembly is parallel to the upper faces of the puzzle plates of the two adjacent board units.

4. The puzzle table as claimed in claim 1, wherein each of the inserting assembly and the receiving assembly is integrally formed on and connected to a corresponding board unit as a one-piece structure.

5. The puzzle table as claimed in claim 3, wherein each board unit further comprises a reinforcing wall integrally extending from the puzzle plate, a drawer cavity formed by the puzzle plate and the reinforcing wall, and a puzzle drawer installed within the drawer cavity.

6. The puzzle table as claimed in claim 5, wherein each inserting assembly is integrally connected to the reinforcing wall of one of the two adjacent board units.

7. The puzzle table as claimed in claim 6, wherein the receiving assembly is integrally connected to the reinforcing wall of the other of the two adjacent board units.

8. The puzzle table as claimed in claim 5, wherein the inserting direction between the inserting assembly and the receiving assembly is substantially parallel to an extending direction of the drawer cavity in at least one of the two adjacent board units.

9. The puzzle table as claimed in claim 5, wherein the inserting direction between the inserting assembly and the receiving assembly is substantially perpendicular to an extending direction of the drawer cavity in one of the at least two board units.

10. The puzzle table as claimed in claim 5, wherein the inserting assembly comprises a first inserting segment and a second inserting segment connected to the first inserting segment.

11. The puzzle table as claimed in claim 10, wherein a cross-sectional area of the second inserting segment is smaller than that of the first inserting segment.

12. The puzzle table as claimed in claim 11, wherein the second inserting segment is positioned between the drawer cavity and the first inserting segment; the second inserting segment are integrally connected to the first inserting segment.

13. The puzzle table as claimed in claim 11, wherein the first inserting segment is positioned between the puzzle plate and the second inserting segment.

14. The puzzle table as claimed in claim 12, wherein the receiving assembly comprises a first receiving slot and a second receiving slot communicated with the first receiving slot; the first inserting segment is completely inserted into the first receiving slot, while the second inserting segment is completely inserted into the second receiving slot.

15. The puzzle table as claimed in claim 14, wherein the first inserting segment comprises an upper plate, a lower plate spaced from the upper plate, inserting plates positioned at both ends of the upper plate to connect the upper plate with the lower plate, and a first inserting groove enclosed by the upper plate, the lower plate, and the inserting plates.

16. The puzzle table as claimed in claim 15, wherein the second inserting segment comprises a fixing portion extending from the reinforcing wall, a first protruding portion extending from the fixing portion towards the puzzle plate and connected to the upper plate of the first inserting segment, and a second inserting groove formed on the fixing portion.

17. The puzzle table as claimed in claim 16, wherein the second inserting groove is communicated with the first inserting groove.

18. The puzzle table as claimed in claim 13, wherein the second inserting segment comprises a main body and a locking portion positioned at one end of the main body; two ends of the locking portion protrude on both sides of the main body.

19. The puzzle table as claimed in claim 18, wherein the second receiving segment comprises a main slot portion and a sub-slot portion positioned at one end of the main slot portion and communicated with the main slot portion.

20. The puzzle table as claimed in claim 19, wherein the second receiving segment further comprises at least one avoidance slot located near the main slot portion, which provides flexibility for the main slot portion.
